(19) United States
(12) Patent Application Publication
(10) Pub. No.: US 2015/0036610 A1
(43) Pub. Date: Feb. 5, 2015

(54) METHOD FOR PROVIDING FEEDBACK OF CHANNEL STATE INFORMATION IN WIRELESS COMMUNICATION SYSTEM AND APPARATUS FOR SAME

(71) Applicant: LG ELECTRONICS INC., Seoul (KR)

(72) Inventors: Hyungtae Kim, Anyang-si (KR); Kijun Kim, Anyang-si (KR); Jonghyun Park, Anyang-si (KR)

(73) Assignee: LG ELECTRONICS INC., Seoul (KR)

(21) Appl. No.: 14/382,978

(22) PCT Filed: Aug. 28, 2013
(86) PCT No.: PCT/KR2013/007720

§ 371 Date: Sep. 4, 2014

Related U.S. Application Data
(60) Provisional application No. 61/694,206, filed on Aug. 28, 2012.
(60) Provisional application No. 61/753,873, filed on Jan. 17, 2013.

(51) Int. Cl. H04B 7/06

(52) U.S. Cl. CPC H04B 7/0626
USPC 370/329

(57) ABSTRACT

Disclosed is a wireless communication system. A method for transmitting channel state information (CSI) in a wireless communication system includes receiving information about reference CSI configuration and following CSI configuration configured to have the same rank indicator (RI) as RI of the reference CSI configuration, determining a wideband precoding matrix index (PMI) according to the following CSI configuration to be the same as a wideband PMI according to the reference CSI configuration when reports of the wideband PMI and the RI according to the reference CSI configuration and reports of the wideband PMI and the RI according to the following CSI configuration collide in one subframe, and transmitting the RI and the wideband PMI according to any one selected from the reference CSI configuration and the following CSI configuration.

### TECHNICAL FIELD

The present invention relates to a wireless communication system, and more particularly, to a method and apparatus for feeding back channel state information (CSI) in a wireless communication system.

### BACKGROUND ART

A 3rd generation partnership project long term evolution (3GPP LTE) communication system will be described below as an exemplary mobile communication system to which the present invention is applicable.

FIG. 1 is a diagram schematically showing a network structure of an evolved universal mobile telecommunications system (E-UMTS) as an exemplary radio communication system. The E-UMTS system has evolved from the conventional UMTS system and basic standardization thereof is currently underway in the 3GPP. The E-UMTS may be generally referred to as a long term evolution (LTE) system. For details of the technical specifications of the UMTS and E-UMTS, refer to Release 7 and Release 8 of “3rd generation partnership project; technical specification group radio access network”.

Referring to FIG. 1, the E-UMTS includes a user equipment (UE), eNBs (or eNode Bs or base stations), and an access gateway (AG) which is located at an end of a network (E-UTRAN) and connected to an external network. The eNBs may simultaneously transmit multiple data streams for a broadcast service, a multicast service, and/or a unicast service.

One or more cells may exist per eNB. A cell is set to use one of bandwidths of 1.25, 2.5, 5, 10, 15, and 20 MHz to provide a downlink or uplink transport service to several UEs. Different cells may be set to provide different bandwidths. The eNB controls data transmission and reception for a plurality of UEs. The eNB transmits downlink scheduling information with respect to downlink data to notify a corresponding UE of a time/frequency domain in which data is to be transmitted, coding, data size, and hybrid automatic repeat and request (HARQ)-related information. In addition, the eNB transmits uplink scheduling information with respect to UL data to a corresponding UE to inform the UE of an available time/frequency domain, coding, data size, and HARQ-related information. An interface for transmitting user traffic or control traffic may be used between eNBs. A core network (CN) may include the AG, a network node for user registration of the UE, and the like. The AG manages mobility of a UE on a tracking area (TA) basis, wherein one TA includes a plurality of cells.

Although radio communication technology has been developed up to LTE based on wideband code division multiple access (WCDMA), the demands and expectations of users and providers continue to increase. In addition, since other radio access technologies continue to be developed, new technology is required to secure competitiveness in the future. For example, decrease of cost per bit, increase of service availability, flexible use of a frequency band, simple structure, open interface, and suitable power consumption by a UE are required.

A UE periodically and/or aperiodically reports current channel state information (CSI) to a BS in order to help effective management of a wireless communication system of the BS. The reported CSI contains results calculated in consideration various situations, and thus, there is a need for a more effective reporting method.

### DISCLOSURE

### Technical Problem

An object of the present invention devised to solve the problem lies in a method and device for reporting channel state information in a radio communication system.

It is to be understood that both the foregoing general description and the following detailed description of the present invention are exemplary and explanatory and are intended to provide further explanation of the invention as claimed.

### Technical Solution

The object of the present invention can be achieved by providing a method for transmitting channel state information (CSI) in a wireless communication system, the method including receiving information about reference CSI configuration and following CSI configuration configured to have the same rank indicator (RI) as RI of the reference CSI configuration, determining a wideband precoding matrix index (PMI) according to the following CSI configuration to be the same as a wideband PMI according to the reference CSI configuration when reports of the wideband PMI and the RI according to the reference CSI configuration and reports of the wideband PMI and the RI according to the following CSI configuration collide in one subframe, and transmitting the RI and the wideband PMI according to any one selected from the reference CSI configuration and the following CSI configuration.

In another aspect of the present invention, provided herein is a method for receiving channel state information (CSI) in a wireless communication system, the method including transmitting information about reference CSI configuration and following CSI configuration configured to have the same rank indicator (RI) as RI of the reference CSI configuration, and receiving RI and wideband PMI according to any one selected from the reference CSI configuration and following CSI configuration when reports of the wideband PMI and the RI according to the reference CSI configuration and reports of the wideband PMI and the RI according to the following CSI configuration collide in one subframe, wherein the wideband PMI according to the following CSI configuration is determined to have the same as the wideband PMI according to the reference CSI configuration.

In another aspect of the present invention, provided herein is a user equipment (UE) for transmitting channel state information (CSI) in a wireless communication system, the UE including a radio frequency (RF) unit, and a processor, wherein the processor is configured to receive information about reference CSI configuration and following CSI configuration configured to have the same rank indicator (RI) as RI of the reference CSI configuration, to determine a wideband precoding matrix index (PMI) according to the following CSI configuration to be the same as a wideband PMI according to the reference CSI configuration when reports of the wideband PMI and the RI according to the reference CSI configuration and reports of the wideband PMI and the RI according to the following CSI configuration collide in one subframe, and to transmit the RI and the wideband PMI according to any one selected from the reference CSI configuration and the following CSI configuration.

In another aspect of the present invention, provided herein is a base station (BS) for receiving channel state information (CSI) in a wireless communication system, the BS including a radio frequency (RF) unit, and a processor, wherein the processor is configured to transmit information about reference CSI configuration and following CSI configuration configured to have the same rank indicator (RI) as RI of the reference CSI configuration, and to receive RI and wideband PMI according to any one selected from the reference CSI configuration and following CSI configuration when reports of the wideband PMI and the RI according to the reference CSI configuration and reports of the wideband PMI and the RI according to the following CSI configuration collide in one subframe, and the wideband PMI according to the following CSI configuration is determined to have the same as the wideband PMI according to the reference CSI configuration.

The following features can be commonly applied to the embodiments of the present invention.

The method may further include dropping CSI reports according to CSI configurations except for CSI configuration having a lowest index when CSI report according to the reference CSI configuration and CSI report according to the following CSI configuration collide.

The method may further include selecting CSI configuration having a lowest index when CSI report according to the reference CSI configuration and CSI report according to the following CSI configuration collide.

Information about the reference CSI configuration and the following CSI configuration may be transmitted via radio resource control (RRC) signaling.

CSI according to the following CSI configuration may be determined based on the wideband PMI according to the reference CSI configuration after the collision

The wideband PMI according to the following CSI configuration may be independently determined from the wideband PMI according to the reference CSI configuration when the reports of the wideband PMI and the RI according to the following CSI configuration do not collide after the collision.

### Advantageous Effects

According to embodiments of the present invention, channel state information (CSI) may be more effectively reported in a wireless communication system.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a diagram schematically showing a network structure of an evolved universal mobile telecommunications system (E-UMTS) as an exemplary radio communication system;

FIG. 2 is a diagram illustrating a control plane and a user plane of a radio interface protocol between a UE and an evolved universal terrestrial radio access network (E-UTRAN) based on a 3rd generation partnership project (3GPP) radio access network standard;

FIG. 3 is a diagram showing physical channels used in a 3GPP system and a general signal transmission method using the same;

FIG. 4 is a diagram illustrating an example of the structure of a radio frame used in a long term evolution (LTE) system;

FIG. 5 is a diagram illustrating a control channel included in a control region of a subframe in a downlink radio frame;

FIG. 6 is a diagram illustrating an uplink subframe structure used in an LTE system;

FIG. 7 illustrates the configuration of a typical multiple input multiple output (MIMO) communication system;

FIGS. 8 to 11 illustrate periodic reporting of channel state information (CSI);

FIGS. 12 and 13 illustrate an exemplary process for periodically reporting CSI when a non-hierarchical codebook is used;

FIG. 14 is a diagram illustrating periodic reporting of CSI when a hierarchical codebook is used;

FIG. 15 illustrates an example of cooperative multipoint transmission/reception (CoMP);

FIG. 16 illustrates a case in which a DL CoMP operation is performed;

FIG. 17 illustrates a case in which type 5 report of the following CSI process collides with type 5 report of the reference CSI process;

FIG. 18 illustrates another embodiment of a case in which type 5 report of the following CSI process collides with type 5 report of the reference CSI process;

FIG. 19 illustrates an embodiment in which three CSI processes collide, which is obtained by expanding the case of FIG. 18; and

FIG. 20 is a diagram illustrating a base station (BS) and a user equipment (UE) to which an embodiment of the present invention is applicable.

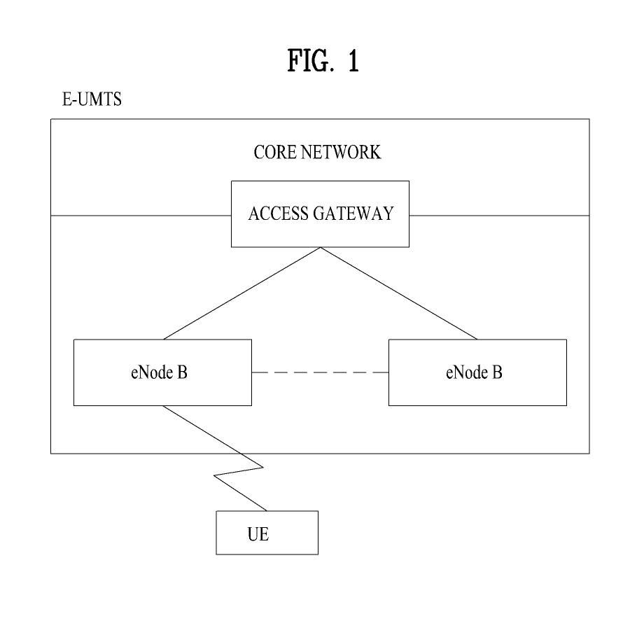

### BEST MODE

The configuration, operation and other features of the present invention will be understood by the embodiments of the present invention described with reference to the accompanying drawings. The following embodiments are examples of applying the technical features of the present invention to a 3rd generation partnership project (3GPP) system.

Although, for convenience, the embodiments of the present invention are described using the LTE system and the LTE-A system in the present specification, the embodiments of the present invention are applicable to any communication system corresponding to the above definition. In addition, although the embodiments of the present invention are described based on a Frequency Division Duplex (FDD) scheme in the present specification, the embodiments of the present invention may be easily modified and applied to a Half-Duplex FDD (H-FDD) scheme or a Time Division Duplex (TDD) scheme.

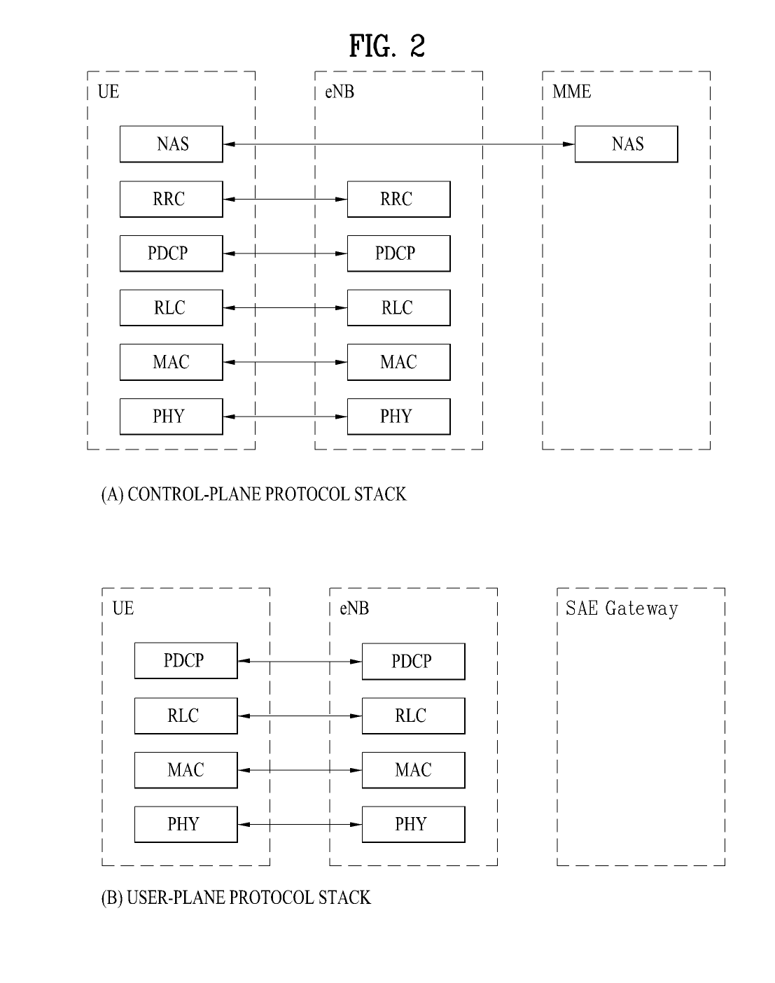

FIG. 2 is a diagram illustrating a control plane and a user plane of a radio interface protocol between a UE and an evolved universal terrestrial radio access network (E-UTRAN) based on a 3GPP radio access network standard. The control plane refers to a path used for transmitting control messages used for managing a call between the UE and the network. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on a higher layer via a transport channel. Data is transported between the MAC layer and the PHY layer via the transport channel. Data is also transported between a physical layer of a transmitting side and a physical layer of a receiving side via a physical channel. The physical channel uses a time and a frequency as radio resources. More specifically, the physical channel is modulated using an orthogonal frequency division multiple access (OFDMA) scheme in downlink and is modulated using a single-carrier frequency division multiple access (SC-FDMA) scheme in uplink.

A medium access control (MAC) layer of a second layer provides a service to a radio link control (RLC) layer of a higher layer via a logical channel. The RLC layer of the second layer supports reliable data transmission. The function of the RLC layer may be implemented by a functional block within the MAC. A packet data convergence protocol (PDCP) layer of the second layer performs a header compression function to reduce unnecessary control information for efficient transmission of an Internet protocol (IP) packet such as an IPv4 packet or an IPv6 packet in a radio interface having a relatively small bandwidth.

A radio resource control (RRC) layer located at the bottom of a third layer is defined only in the control plane and is responsible for control of logical, transport, and physical channels in association with configuration, re-configuration, and release of radio bearers (RBs). The RB is a service that the second layer provides for data communication between the UE and the network. To accomplish this, the RRC layer of the UE and the RRC layer of the network exchange RRC messages. The UE is in an RRC connected mode if an RRC connection has been established between the RRC layer of the radio network and the RRC layer of the UE. Otherwise, the UE is in an RRC idle mode. A Non-Access Stratum (NAS) layer located above the RRC layer performs functions such as session management and mobility management.

One cell of the eNB is set to use a bandwidth such as 1.25, 2.5, 5, 10, 15 or 20 MHz to provide a downlink or uplink transmission service to several UEs. Different cells may be set to provide different bandwidths.

Downlink transport channels for transmission of data from the network to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through a downlink SCH and may also be transmitted through a downlink multicast channel (MCH). Uplink transport channels for transmission of data from the UE to the network include a random access channel (RACH) for transmission of initial control messages and an uplink SCH for transmission of user traffic or control messages. Logical channels, which are located above the transport channels and are mapped to the transport channels, include a broadcast control channel (BCCH), a paging control channel (PCCH), a common control channel (CCCH), a multicast control channel (MCCH), and a multicast traffic channel (MTCH).

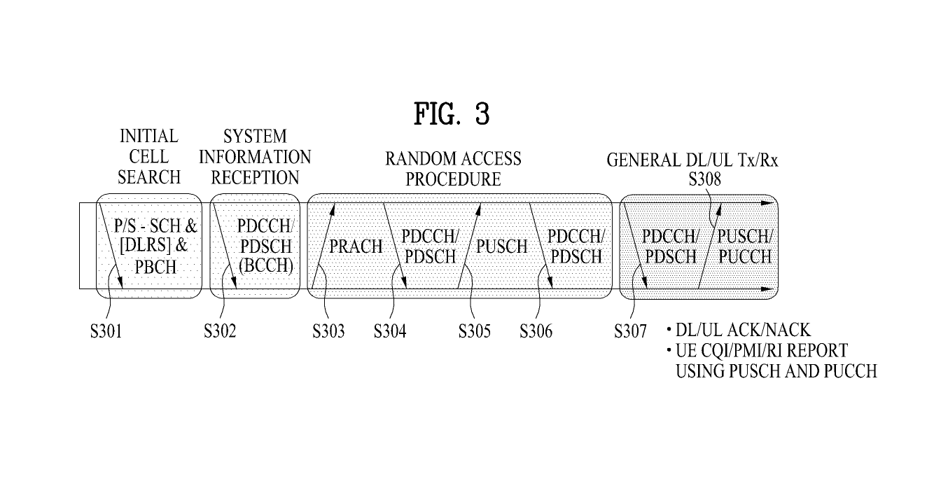

FIG. 3 is a diagram showing physical channels used in a 3GPP system and a general signal transmission method using the same.

A UE performs an initial cell search operation such as synchronization with an eNB when power is turned on or the UE enters a new cell (S301). To this end, the UE may receive a Primary synchronization channel (P-SCH) and a secondary synchronization channel (S-SCH) from the eNB, perform synchronization with the eNB, and acquire information such as a cell ID. Thereafter, the UE may receive a physical broadcast channel from the eNB so as to acquire broadcast information within the cell. Meanwhile, the UE may receive a Downlink Reference Signal (DL RS) so as to confirm a downlink channel state in the initial cell search step.

The UE which completes the initial cell search may receive a Physical Downlink Control Channel (PDCCH) and a Physical Downlink Shared Channel (PDSCH) according to information included in the PDCCH so as to acquire more detailed system information (S302).

Meanwhile, if the eNB is initially accessed or radio resources for signal transmission are not present, the UE may perform a Random Access Procedure (RACH) (step S303 to S306) with respect to the eNB. To this end, the UE may transmit a specific sequence through a Physical Random Access Channel (PRACH) as a preamble (S303 and S305), and receive a response message of the preamble through the PDCCH and the PDSCH corresponding thereto (S304 and S306). In the case of contention-based RACH, a contention resolution procedure may be further performed.

The UE which performs the above procedures may perform PDCCH/PDSCH reception (S307) and physical uplink shared channel (PUSCH)/physical uplink control channel (PUCCH) transmission (S308) as a general uplink/downlink signal transmission procedure. In particular, the UE receives downlink control information (DCI) through the PDCCH. Here, the DCI contains control information such as resource allocation information about a UE and has different formats according to according to different usages of DCI.

The control information transmitted from the UE to the eNB in uplink or transmitted from the eNB to the UE in downlink includes a downlink/uplink ACK/NACK signal, a channel quality indicator (CQI), a precoding matrix index (PMI), a rank indicator (RI), and the like. In the case of the 3GPP LTE system, the UE may transmit the control information such as CQI/PMI/RI through the PUSCH and/or the PUCCH.

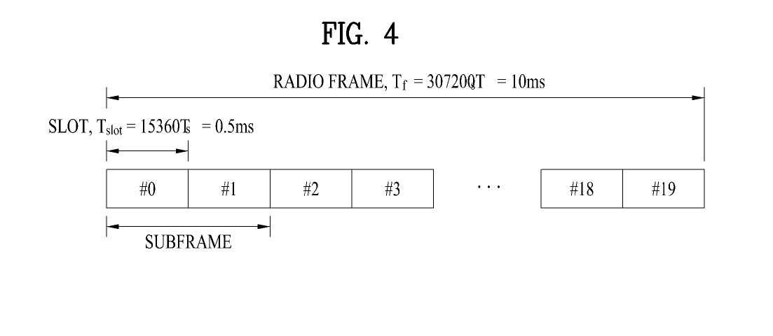

FIG. 4 is a diagram illustrating an example of the structure of a radio frame used in an LTE system.

Referring to FIG. 4, a radio frame has a length of 10 ms (327200×Ts) and includes ten subframes having an equal size. Each subframe has a length of 1 ms and includes two slots each having a length of 0.5 ms (15360×Ts). Here, Ts denotes a sampling time, which is represented as Tx=1/(15 kHz×2048)=3.2552×10⁻⁸ (approximately 33 ns). A slot includes a plurality of orthogonal frequency division multiplexing (OFDM) symbols in the time domain and a plurality of resource blocks in the frequency domain. In the LTE system, one resource block includes 12 subcarriers×7(6) OFDM symbols. A unit time for transmitting data, transmission time interval (TTI), may be set to one or more subframes. The above-described radio frame structure is exemplary and the number of subframes included in the radio frame, the number of slots included in one subframe, and the number of OFDM symbols or SC-FDMA symbols included in each slot may be changed in various manners.

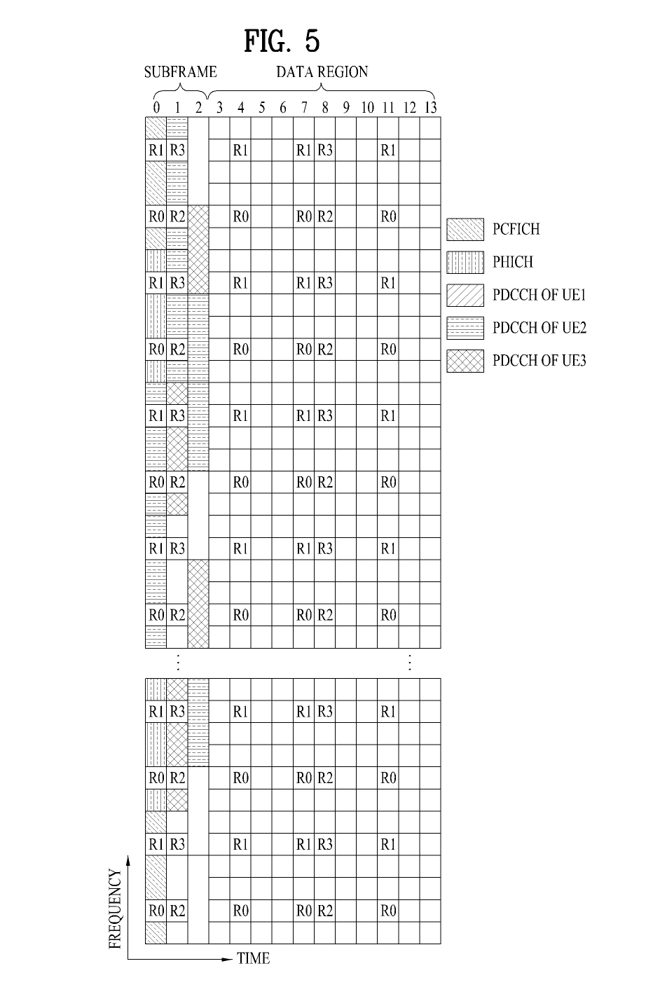

FIG. 5 is a diagram illustrating a control channel included in a control region of a subframe in a downlink radio frame.

Referring to FIG. 5, a subframe includes 14 OFDM symbols. The first to third OFDM symbols are used as a control region and the remaining 13 to 11 OFDM symbols are used as a data region, according to subframe settings. In FIG. 5, R1 to R4 denote reference signals (RS) or pilot signals for antennas 0 to 3. The RS is fixed to a constant pattern within a subframe regardless of the control region and the data region. A control channel is allocated to resources, to which the RS is not allocated, in the control region, and a traffic channel is also allocated to resources, to which the RS is not allocated, in the control region. Examples of the control channel allocated to the control region include a physical control format indicator channel (PCFICH), physical hybrid-arq indicator channel (PHICH), physical downlink control channel (PDCCH), etc.

The physical control format indicator channel (PCFICH) informs the UE of the number of OFDM symbols used for the PDCCH per subframe. The PCFICH is located at a first OFDM symbol and is set prior to the PHICH and the PDCCH. The PCFICH includes four resource element groups (REGs) and the REGs are dispersed in the control region based on a cell identity (ID). One REG includes four resource elements (REs). An RE indicates a minimum physical resource defined as one subcarrier×one OFDM symbol. The PCFICH has a value of 1 to 3 or 2 to 4 and is modulated using a quadrature phase shift keying (QPSK) scheme.

The physical Hybrid-ARQ indicator channel (PHICH) is used to transmit HARQ ACK/NACK for uplink transmission. That is, the PHICH refers to a channel in which DL ACK/NACK information for UL HARQ is transmitted. The PHICH includes one REG and is scrambled on a cell-specific basis. ACK/NACK is indicated by one bit and is modulated using binary phase shift keying (BPSK). The modulated ACK/NACK is spread with a spreading factor (SF) of 2 or 4. A plurality of PHICHs mapped to the same resource constitutes a PHICH group. The number of multiplexed PHICHs in the PHICH group is determined according to the number of SFs. The PHICH (group) is repeated through times in order to acquire diversity gain in the frequency domain and/or time domain.

The physical downlink control channel (PDCCH) is allocated to the first n OFDM symbols of a subframe. Here, n is an integer of 1 or more and is indicated by a PCFICH. The PDCCH includes one or more control channel elements (CCEs). The PDCCH informs each UE or a UE group of information associated with resource allocation of a paging channel (PCH) and a downlink-shared channel (DL-SCH), both of which are transport channels, uplink scheduling grant, HARQ information, etc. The paging channel (PCH) and the downlink-shared channel (DL-SCH) are transmitted through a PDSCH. Accordingly, the eNB and the UE transmit and receive data through the PDSCH except for specific control information or specific service data.

Information indicating to which UE (one or a plurality of UEs) data of the PDSCH is transmitted and information indicating how the UEs receive and decode the PDSCH data are transmitted in a state of being included in the PDCCH. For example, it is assumed that a specific PDCCH is CRC-masked with a Radio Network Temporary Identity (RNTI) “A”, and information about data transmitted using radio resource (e.g., frequency location) “B” and transmission format information (e.g., transmission block size, modulation scheme, coding information, or the like) “C” is transmitted via a specific subframe. In this case, one or more UEs located within a cell monitor a PDCCH using its own RNTI information, and if one or more UEs having “A” RNTI are present, the UEs receive the PDCCH and receive the PDSCH indicated by “B” and “C” through the information about the received PDCCH.

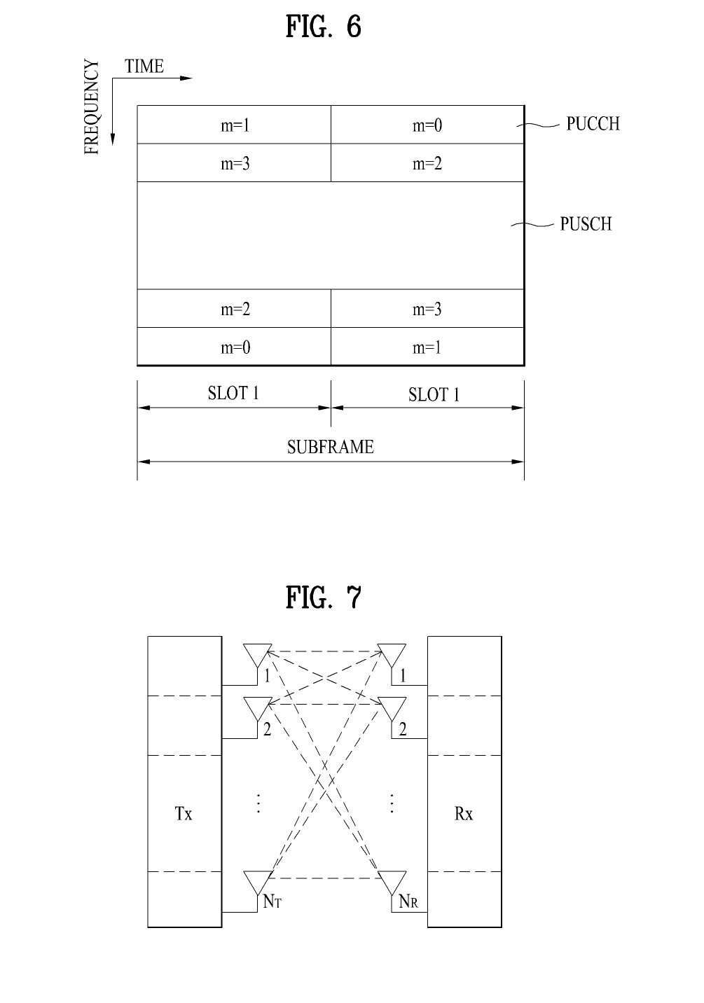

FIG. 6 is a diagram illustrating an uplink subframe structure used in an LTE system.

Referring to FIG. 6, a UL subframe may be divided into a region to which physical uplink control channel (PUCCH) for carrying control information is allocated and a region to which physical uplink shared channel (PUSCH) for carrying user data is allocated. The middle of the subframe is allocated to the PUSCH, while both sides of the data region in the frequency domain are allocated to the PUCCH. Control information transmitted on the PUCCH may include a Hybrid Automatic Repeat request acknowledgement/negative acknowledgement (HARQ ARCK/NACK), a Channel Quality Indicator (CQI) representing a downlink channel state, a rank indicator (RI) for multiple input multiple output (MIMO), a scheduling request (SR) requesting uplink resource allocation. A PUCCH for one UE uses one resource block that occupies different frequencies in slots in a subframe. That is, two resource blocks allocated to the PUCCH is frequency hopped at a slot boundary. In particular, PUCCHs with m=0, m=1, and m=2 are allocated to a subframe in FIG. 6.

Multiple Input Multiple Output (MIMO) System

Now a description will be given of a Multiple Input Multiple Output (MIMO) system. MIMO can increase the transmission and reception efficiency of data by using a plurality of transmission (Tx) antennas and a plurality of reception (Rx) antennas. That is, with the use of multiple antennas at a transmitter or a receiver, MIMO can increase capacity and improve performance in a wireless communication system. The term “MIMO” is interchangeable with “multi-antenna”.

The MIMO technology does not depend on a single antenna path to receive a whole message. Rather, it completes the message by combining data fragments received through a plurality of antennas. MIMO can increase data rate within a cell area of a predetermined size or extend system coverage at a given data rate. In addition, MIMO can find its use in a wide range including mobile terminals, relays, etc. MIMO can overcome a limited transmission capacity encountered with the conventional single-antenna technology in mobile communication.

FIG. 7 illustrates the configuration of a typical MIMO communication system. Referring to FIG. 7, a transmitter has N_{T} Tx antennas and a receiver has N_{R} Rx antennas. The simultaneous use of a plurality of antennas at both the transmitter and the receiver increases a theoretical channel transmission capacity, compared to use of a plurality of antennas at only one of the transmitter and the receiver. The channel transmission capacity increases in proportion to the number of antennas. Therefore, transmission rate and frequency efficiency are increased. Given a maximum transmission rate Rₒ that may be achieved with a single antenna, the transmission rate may be increased, in theory, to the product of Rₒ and a transmission rate increase rate R, in the case of multiple antennas. Rᵢ is the smaller value between N_{T} and N_{R}.

Rᵢ=min(N_{T},N_{R}) [Equation 1]

For instance, a MIMO communication system with four Tx antennas and four Rx antennas may achieve a four-fold increase in transmission rate theoretically, relative to a single-antenna system. Since the theoretical capacity increase of the MIMO system was verified in the middle 1990s, many techniques have been actively proposed to increase data rate in real implementation. Some of the techniques have already been reflected in various wireless communication standards for 3G mobile communications, future-generation wireless local area network (WLAN), etc.

Concerning the research trend of MIMO up to now, active studies are underway in many respects of MIMO, inclusive of studies of information theory related to calculation of multi-antenna communication capacity in diverse channel environments and multiple access environments, studies of measuring MIMO radio channels and MIMO modeling, studies of time-space signal processing techniques to increase transmission reliability and transmission rate, etc.

Communication in a MIMO system with N_{T} Tx antennas and N_{R} Rx antennas as illustrated in FIG. 7 will be described in detail through mathematical modeling. Regarding a transmission signal, up to N_{T} pieces of information can be transmitted through the N_{T} Tx antennas, as expressed as the vector shown in Equation 2 below.

s=[s₁,s₂, . . . ,s_{N}_{_{T}}]^{T} [Equation 2]

A different transmission power may be applied to each piece of transmission information, s₁, s₂, . . . , s_{N}_{_{T}}. Let the transmission power levels of the transmission information be denoted by P₁, P₂, . . . , P_{N}_{_{T}}, respectively. Then the transmission power-controlled transmission information vector is given as

ŝ=[ŝ₁,ŝ₂, . . . ,ŝ_{N}_{_{T}}]^{T}=[P₁s₁,P₂s₂, . . . ,P_{N}_{_{T}}s_{N}_{_{T}}]^{T} [Equation 3]

The transmission power-controlled transmission information vector ŝ may be expressed as follows, using a diagonal matrix P of transmission power.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 4 ]$$

N_{T} transmission signals x₁, x₂, . . . , x_{N}_{_{T}} may be generated by multiplying the transmission power-controlled information vector ŝ by a weight matrix W. The weight matrix W functions to appropriately distribute the transmission information to the Tx antennas according to transmission channel states, etc. These N_{T} transmission signals x₁, x₂, . . . , x_{N}_{_{T}} are represented as a vector x, which may be determined by Equation 5 below. Herein, wᵢⱼ denotes a weight between a j^{th} piece of information and an i^{th} Tx antenna and W is referred to as a weight matrix or a precoding matrix.

$$\begin{matrix}x = [ \begin{matrix}{x}_{1} \\ {x}_{2} \\ ⋮ \\ {x}_{i} \\ ⋮ \\ {x}_{{N}_{T}}\end{matrix} ] \\ = [ \begin{matrix}{w}_{11} & {w}_{12} & … & {w}_{1 {N}_{T}} \\ {w}_{21} & {w}_{22} & … & {w}_{2 {N}_{t}} \\ ⋮ & & ⋱ & \\ {w}_{i 1} & {w}_{i 2} & … & {w}_{i {N}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] \\ = W \hat{s} \\ = WPs\end{matrix} \qquad [ Equation 5 ]$$

In general, the rank of a channel matrix is the maximum number of different pieces of information that can be transmitted on a given channel, in its physical meaning. Therefore, the rank of a channel matrix is defined as the smaller between the number of independent rows and the number of independent columns in the channel matrix. The rank of the channel matrix is not larger than the number of rows or columns of the channel matrix. The rank of a channel matrix H, rank(H) satisfies the following constraint.

rank(H)≦min(N_{T},N_{R}) [Equation 6]

A different piece of information transmitted in MIMO is referred to as ‘transmission stream’ or shortly ‘stream’. The ‘stream’ may also be called ‘layer’. It is thus concluded that the number of transmission streams is not larger than the rank of channels, i.e. the maximum number of different pieces of transmittable information. Thus, the channel matrix H is determined by

#of streams≦rank(H)≦min(N_{T},N_{R}) [Equation 7]

“# of streams” denotes the number of streams. One thing to be noted herein is that one stream may be transmitted through one or more antennas.

One or more streams may be mapped to a plurality of antennas in many ways. The stream-to-antenna mapping may be described as follows depending on MIMO schemes. If one stream is transmitted through a plurality of antennas, this may be regarded as spatial diversity. When a plurality of streams is transmitted through a plurality of antennas, this may be spatial multiplexing. Needless to say, a hybrid scheme of spatial diversity and spatial multiplexing in combination may be contemplated.

Channel State Information (CSI) Feedback

Channel State Information (CSI) reporting will be described below. In the current LTE standard, there are two MIMO transmission schemes, open-loop MIMO operating without channel information and closed-loop MIMO operating with channel information. Particularly in the closed-loop MIMO, each of an eNB and a UE may perform beamforming based on CSI to obtain the multiplexing gain of MIMO Tx antennas. To acquire CSI from the UE, the eNB may transmit a reference signal (RS) to the UE and may command the UE to feed back measured CSI on a PUCCH or PUSCH.

CSI is classified largely into three information types, RI, PMI, and CQI. An RI is information about a channel rank, as described before. The channel rank is the number of streams that a UE can receive in the same time-frequency resources. Because the RI is determined mainly according to the long-term fading of a channel, the RI may be fed back to an eNB in a longer period than a PMI and a CQI.

A PMI is the index of a UE-preferred eNB precoding matrix determined based on a metric such as signal to interference and noise ratio (SINR), reflecting the spatial characteristics of channels. A CQI represents a channel strength. In general, the CQI reflects a reception SINR that the eNB can achieve with a PMI.

An advanced system such as an LTE-A system considers achievement of an additional multi-user diversity by the use of Multi-User MIMO (MU-MIMO). Due to the existence of interference channels between UEs multiplexed in an antenna domain in MU-MIMO, the accuracy of CSI may significantly affect interference with other multiplexed UEs as well as a UE that reports the CSI. Accordingly, more accurate CSI than in Single User MIMO (SU-MIMO) should be reported in MU-MIMO.

In this context, the LTE-A standard designs a final PMI separately as a long-term and/or wideband PMI, W1 and a short-term and/or subband PMI, W2.

For example, the long-term covariance matrix of channels expressed as Equation 8 below may be used for hierarchical codebook transformation that configures one final PMI with W1 and W2.

W=norm(W1W2) [Equation 8]

In Equation 8 above, W2 is a short-term PMI, which is a codeword of a codebook reflecting short-term channel information, W is a codeword of a final codebook, and norm(A) is a matrix obtained by normalizing the norm of each column of matrix A to 1.

Conventionally, the codewords W1 and W2 are given as Equation 9 below.

$$W 1 ( i ) = [ \begin{matrix}{X}_{i} & 0 \\ 0 & {X}_{i}\end{matrix} ] , \\ where {X}_{i} is Nt \text{/} 2 by matrix . \\ W 2 ( j ) = \overbrace{[ \begin{matrix}{e}_{M}^{k} & {e}_{M}^{i} & & {e}_{M}^{m} \\ & & … & \\ {α}_{j} {e}_{M}^{k} & {β}_{j} {e}_{M}^{i} & & {γ}_{j} {e}_{M}^{m}\end{matrix} ] }^{r columns} ( if rank = r ) , \\ where 1 \leq k , l , m \leq M \\ and \\ k , l , m are integer . \qquad [ Equation 9 ]$$

Here, Nt is the number of Tx antennas and M is the number of columns of a matrix Xi, which means that the matrix Xi has total M candidate column vectors. e_{M}^{k}, e_{M}^{l}, and e_{M}^{m} are column vectors that have elements of 0 except for only kₜₕ, lₜₕ, and mₜₕ elements that are 1 among M elements and are kₜₕ, lₜₕ, and mₜₕ column vectors of Xi. αⱼ, βⱼ, and γⱼ are complex values and indicate that phase rotation is applied to the kₜₕ, lₜₕ, and mₜₕ column vectors of the matrix in order to choose these column vectors, respectively. i is an integer equal to or greater than 0 and is a PMI index indicating W1. j is an integer equal to or greater than 0 and is a PMI index indicating W2.

In Equation 9 above, the codewords are designed so as to reflect correlation characteristics between established channels, if cross polarized antennas are arranged densely, for example, the distance between adjacent antennas is equal to or less than a half of a signal wavelength. The cross polarized antennas may be divided into a horizontal antenna group and a vertical antenna group and the two antenna groups are co-located, each having the property of a uniform linear array (ULA) antenna.

Therefore, the correlations between antennas in each group have the same linear phase increment property and the correlation between the antenna groups is characterized by phase rotation. Since a codebook is eventually quantized values of channels, it is necessary to design a codebook, reflecting channel characteristics. For the convenience of description, a rank-1 codeword designed in the above manner may be given as Equation 10 below.

$$W 1 ( i ) * W 2 ( j ) = [ \begin{matrix}{X}_{i} ( k ) \\ {α}_{j} {X}_{i} ( k )\end{matrix} ] \qquad [ Equation 10 ]$$

In [Equation 10], a codeword is expressed as an N_{T}×1 vector where N_{T} is the number of Tx antennas and the codeword is composed of an upper vector Xᵢ(k) and a lower vector αⱼXᵢ(k), representing the correlation characteristics of the horizontal and vertical antenna groups, respectively. Preferably, Xᵢ(k) is expressed as a vector having the linear phase increment property, reflecting the correlation characteristics between antennas in each antenna group. For example, a Discrete Fourier Transform (DFT) matrix may be used for Xᵢ(k).

As described above, CSI in an LTE system includes, but is not limited to, CQI, PMI, and RI. Some or all of CQI, PMI, and RI may be transmitted according to a transmission mode of a UE. A case in which CSI is periodically transmitted is referred to as periodic reporting and a case in which CSI is transmitted according to request of a BS is referred to as aperiodic reporting. In case of aperiodic reporting, a request bit contained in UL scheduling information from the BS is transmitted to the UE. Then, the UE transmits CSI obtained in consideration of a transmission mode of the UE to the BS via a UL data channel (PUSCH). In case of periodic reporting, periods, offset for a corresponding period, etc. are signaled in units of subframes via an upper layer signal for each respective UE in a semi-static manner. Each UE transmits CSI obtained in consideration of a transmission mode of the UE to the BS via a UL control channel (PUCCH) according to a predetermined period. When UL data and CSI are simultaneously present in a subframe for transmitting CSI, the CSI is transmitted through a UL data channel (PUSCH) together with the data. The BS transmits transmission timing information appropriate for each respective UE to the UE in consideration of a channel state of each UE, a distribution state of UEs in a cell, etc. The transmission timing information includes a period, offset, etc. for transmission of CSI and may be transmitted to each UE through an RRC message.

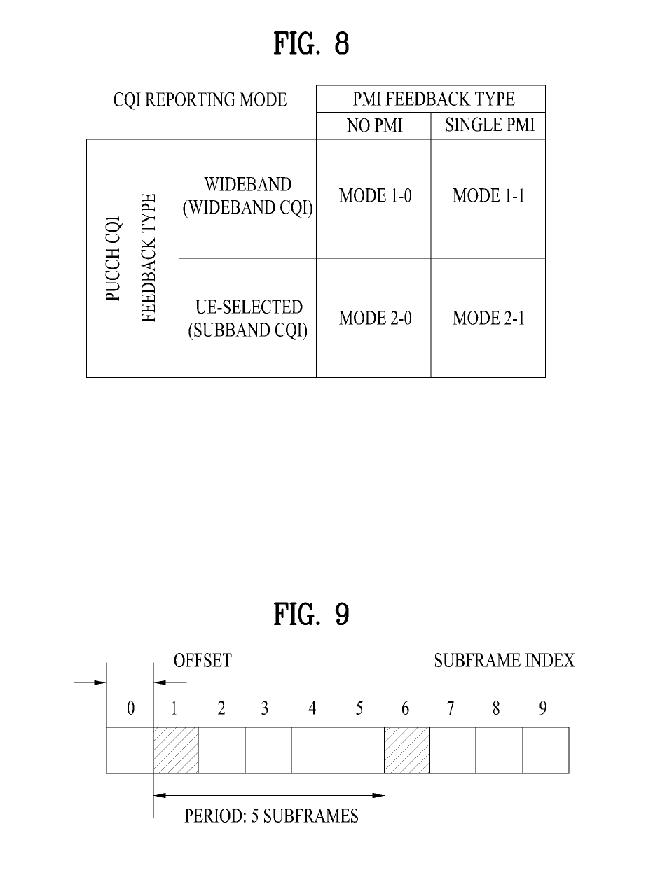

FIGS. 8 to 11 illustrate periodic reporting of CSI in LTE.

Referring to FIG. 8, an LTE system has four CQI reporting modes. In detail, the CQI reporting mode is classified into WB CQI and SB CQI according to a CQI feedback type and is classified into no PMI and single PMI according to whether PMI is transmitted. Each UE receives information formed by combining a period and offset via RRC signaling in order to periodically report CQI.

FIG. 9 illustrates an example in which a UE transmits CSI when information indicating {period ‘5’ and offset ‘1’} is signaled to the UE. Referring to FIG. 9, upon receiving the information indicating {period ‘5’ and offset ‘1’}, the UE transmits CSI in units of 5 subframes with an offset of one subframe in a direction in which a subframe index increases from a 0ₜₕ subframe. CSI. CSI is basically transmitted via a PUCCH. However, when PUSCH for transmission is present at the same time, CSI is transmitted together with data via PUSCH. A subframe index is formed by combining a system frame number (or a radio frame index)(nf) and a slot index (ns, 0 to 19). Since a subframe includes 2 slots, a subframe index may be defined according to 10*nf+floor(ns/2). floor( ) indicates a rounddown function.

There are a type for transmitting only WB CQI and a type for both WB CQI and SB CQI. In case of the type for transmitting only WB CQI, CQI information about an entire band in a subframe corresponding to every CQI transmission period is transmitted. As illustrated in FIG. 8, when PMI needs to be also transmitted according to a PMI feedback type, PMI information is transmitted together with CQI information. In case of the type for transmitting both WB CQI and SB CQI, WB CQI and SB CQI are alternately transmitted.

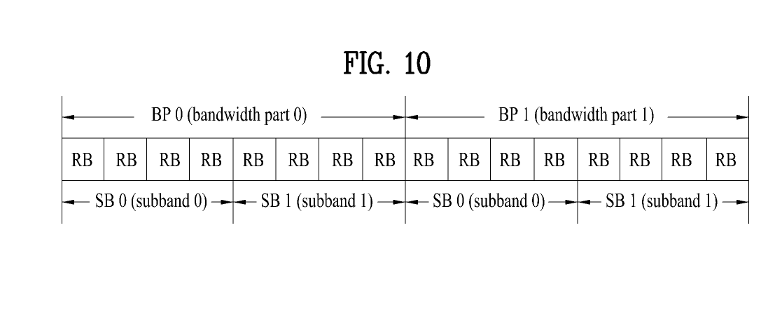

FIG. 10 is a diagram illustrating an exemplary system having a system band with 16 RBs. In this case, it is assumed that the system band includes two bandwidth parts (BPs) BP0 and BP1 which each include two subbands SB0 and SB1 which each include four RBs. This assumption is purely exemplary for explanation. The number BPs and the size of each SB may vary according to the size of the system band. In addition, the number of SBs included in each BP may vary according to the number of RBs, the number of BPs, and the size of SB.

In case of the type for transmission both WB CQI and SB CQI, WB CQI is transmitted in a first CQI transmission subframe, and CQI about an SB having a better channel state from SB0 and SB1, belonging to BP0, and an index (e.g., a subband selection indicator (SSI) corresponding to the corresponding SB are transmitted in a next CQI transmission subframe. Then, CQI about an SB having a better channel state from SB0 and SB1, belonging to BP1, and an index corresponding to the corresponding SB is transmitted in a next transmission subframe. Likewise, after WB CQI is transmitted, CQI information about BPs is sequentially transmitted. CQI information about each BP between two WB CQIs may be sequentially transmitted once to four times. For example, when CQI information about each BP between two WB CQIs is sequentially transmitted once, CQI information may be transmitted in an order of WB CQI [symbol] BP0 CQI [symbol] BP1 CQI [symbol] WB CQI. In addition, when CQI information about each BP between two WB CQIs is sequentially transmitted four times, CQI information may be transmitted in an order of WB CQI [symbol] BP0 CQI [symbol] BP1 CQI [symbol] BP0 CQI [symbol] BP1 CQI [symbol] BP0 CQI [symbol] BP1 CQI [symbol] BP0 CQI [symbol] BP1 CQI [symbol] WB CQI. Information about a number of times that each BP CQI is sequentially transmitted is signaled in an upper layer (e.g., an RRC layer).

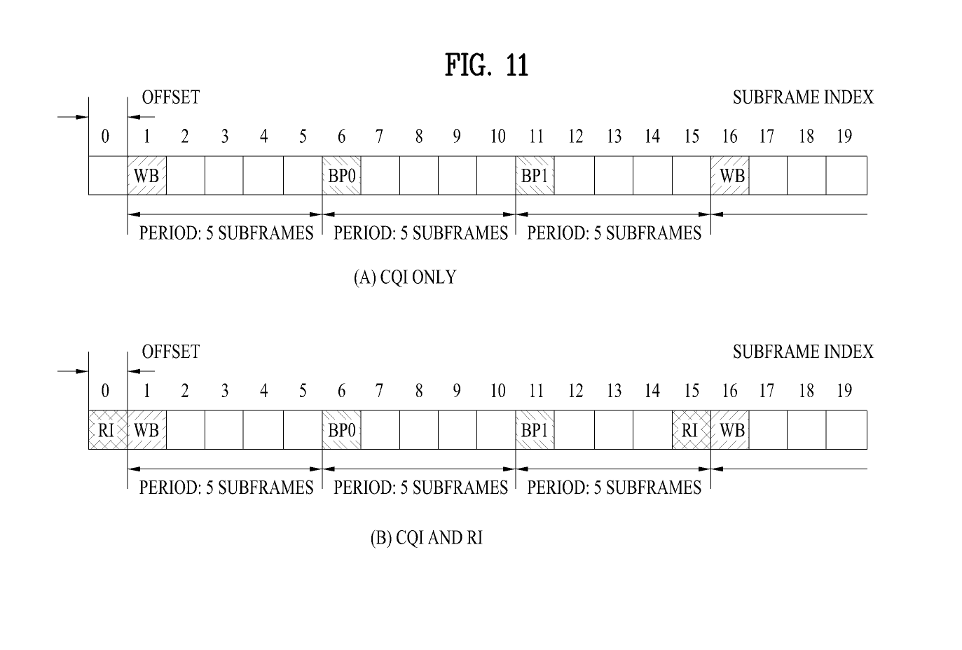

FIG. 11(a) is a diagram illustrating an example in which a UE transmits both WB CQI and SB CQI when information indicating {period ‘5’ and offset ‘1’} is signaled to the UE. Referring to FIG. 11(a), CQI may be transmitted in only a subframe corresponding to signaled period and offset irrespective a type of CQI. FIG. 11(b) illustrates a case in which RI is additionally transmitted in a case of FIG. 11(a). RI may be signaled from an upper layer (e.g., an RRC layer) via a combination of a multiple of WB CQI transmission period and offset in the corresponding transmission period. Offset of RI is signaled as a relative value based on offset of CQI. For example, when the offset of CQI is ‘1’ and the offset of RI is ‘0’, RI may have the same offset as CQI. The offset of RI is defined as 0 and a negative value. In detail, FIG. 11(b) assumes a case in which a RI transmission period is one time of a WB CQI transmission period and the offset of RI is ‘−1’ in the same environment as in FIG. 11(a). Since the RI transmission period is one time of the WB CQI transmission period, transmission periods of CSI are actually the same. Since the offset of RI is ‘−1’, RI is transmitted based on ‘−1’ (that is, subframe #0) with respect to offset ‘1’ of CQI in FIG. 11(a). When the offset of RI is ‘0’, transmission subframes of WB CQI and RI overlap each other. In this case, WB CQI is dropped and RI is transmitted.

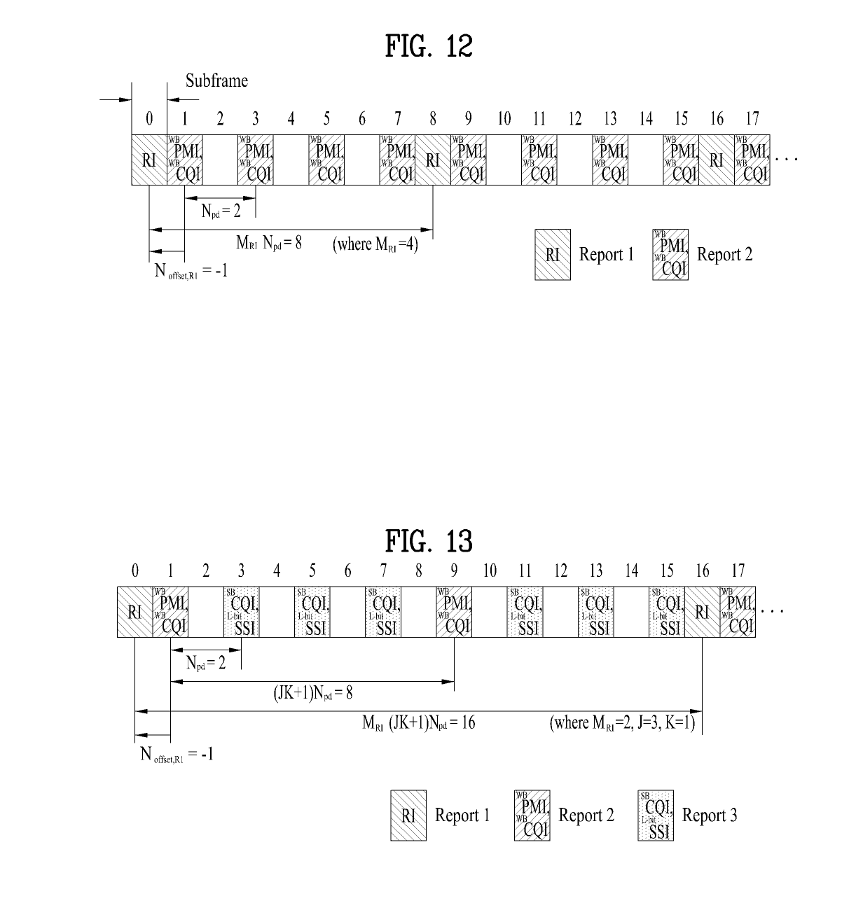

FIG. 12 is a diagram illustrating CSI feedback in case of Mode 1-1 of FIG. 8.

Referring to FIG. 12, the CSI feedback is composed of transmission of two types of report contents, Report 1 and Report 2. In detail, RI is transmitted in Report 1 and WB PMI and WB CQI are transmitted in Report 2. Report 2 is transmitted in a subframe with a subframe index satisfying (10*nf+floor(ns/2)−N offset, CQI)mod(Npd)=0. N offset, CQI corresponds to an offset value for transmission of PMI/CQI illustrated in FIG. 9. FIG. 12 illustrates a case of N offset, CQI=1. Npd 5 is a subframe interval between adjacent Reports 2. FIG. 12 illustrates a case of Npd=2. Report 1 is transmitted in a subframe with a subframe index satisfying (10*nf+floor(ns/2)−N offset, CQI-N offset, RI)mod(MRI*Npd)=0. M_{RI} is determined via upper layer signaling. In addition, N offset, RI corresponds to a relative offset value for transmission of RI illustrated in FIG. 11. FIG. 12 illustrates a case of M_{RI}=4 and N offset, RI=−1.

FIG. 13 is a diagram illustrating CSI feedback in case of Mode 2-1 illustrated in FIG. 8.

Referring to FIG. 13, the CSI feedback is composed of transmission of three types of report contents, Report 1, Report 2, and Report 3. In detail, RI is transmitted in Report 1, WB PMI and WB CQI are transmitted in Report 2, and subband (SB) CQI and L-bit subband selection indicator (SSI) are transmitted in Report 3. Report 2 or Report 3 is transmitted in a subframe with a subframe index satisfying (10*nf+floor(ns/2)−N offset, CQI)mod(Npd)=0. In particular, Report 2 is transmitted in a subframe with a subframe index satisfying (10*nf+floor(ns/2)−N offset, CQI)mod(H*Npd)=0. Thus, Report 2 is transmitted every interval of H*Npd and subframes between adjacent Reports 2 are filled by transmitting Report 3. In this case, H satisfies H=J*K+1, where J is the number of bandwidth parts (BPs). K indicates the number of continuously-performed full cycles for selecting a subband for each of different BPs once and transmitting subbands over all BPs and is determined via upper layer signaling. FIG. 13 illustrates a case of Npd=2, J=3, and K=1. Report 1 is transmitted in a subframe with a subframe index satisfying (10*nf+floor(ns/2)−N offset, CQI-N offset, RI)mod(MRI*(J*K+1)*Npd)=0. FIG. 13 illustrates a case of M_{R1}=2 and N offset, RI=−1.

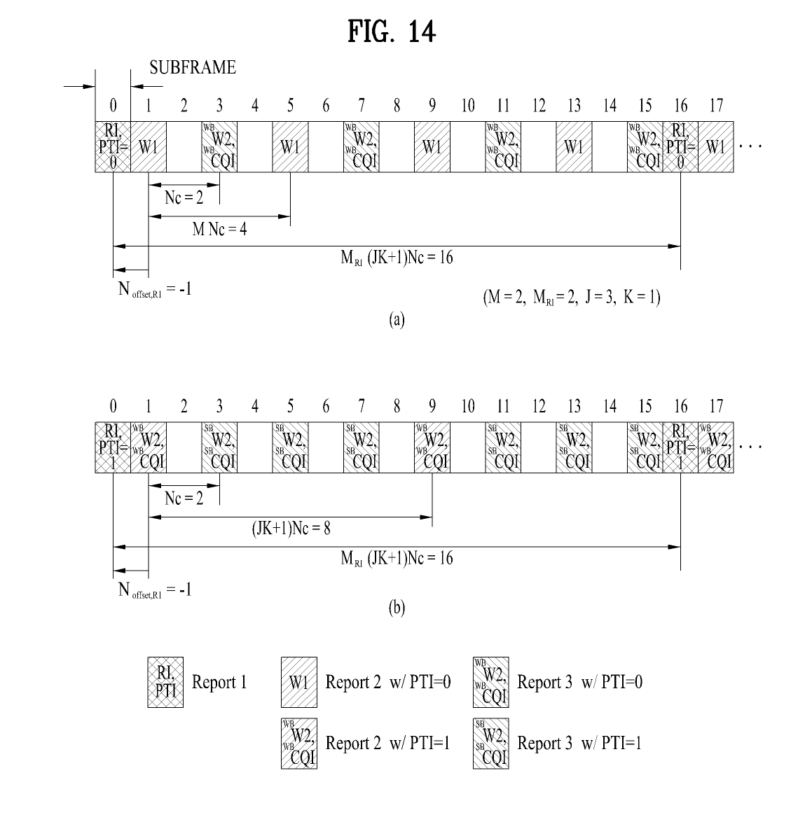

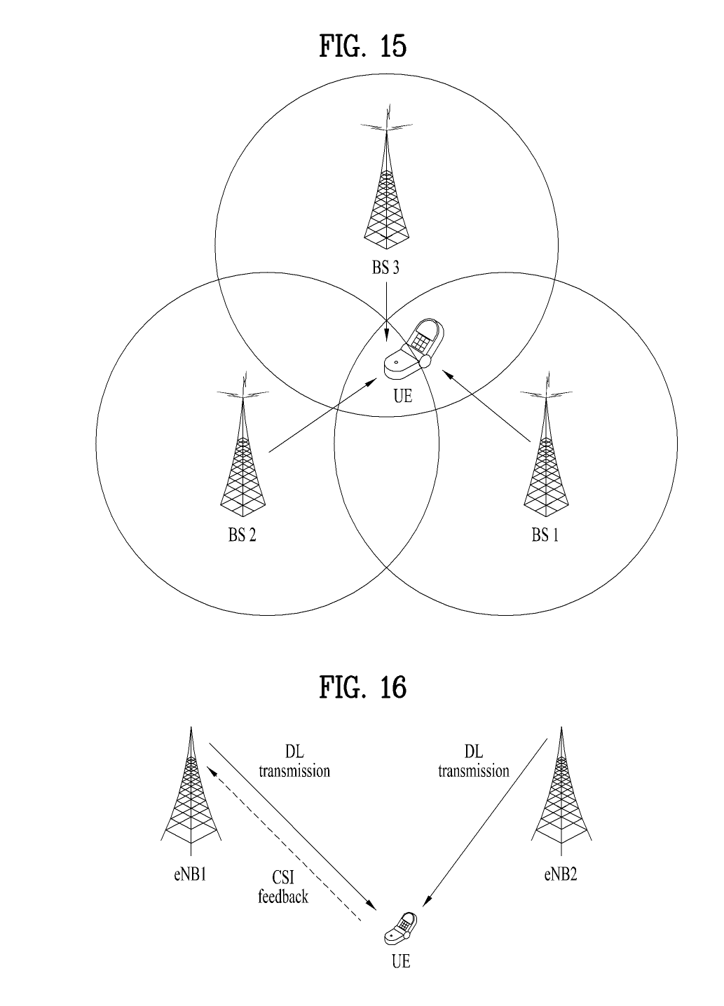

FIG. 14 is a diagram illustrating periodic reporting of CSI that has been discussed in an LTE-A system. When BS has 8 Tx antennas, in case of Mode 2-1, a precoder type indication (PTI) parameter as a 1-bit indicator is set, and a periodic reporting mode subdivided into two types according to a PTI value is considered, as illustrated in FIG. 15. In FIG. 14, W1 and W2 indicate hierarchical codebook described with reference to Equations 8 and 9 above. When both W1 and W2 are determined, precoding matrix W completed by combining W1 and W2 is determined.

Referring to FIG. 14, In case of periodic reporting, different contents corresponding to Report 1, Report 2, and Report 3 are reported according to different reiteration periods. RI and 1-bit PTI are reported in Report 1. WB (WideBand) W1 (when PTI=0) or WB W2 and WB CQI (when PTI=1) are reported in Report 2. WB W2 and WB CQI (when PTI=0) or subband (SB) W2 and SB CQI (when PTI=1) are reported in Report 3.

Report 2 and Report 3 are transmitted in a subframe (for convenience, referred to as a first subframe set) with a subframe index satisfying (10*nf+floor(ns/2)−N offset, CQI) mod (NC)=0. N offset, CQI corresponds to an offset value for transmission of PMI/CQI illustrated in FIG. 9. In addition, Nc indicates a subframe interval between adjacent Reports 2 or Reports 3. FIG. 14 illustrates an example in which N offset, CQI=1 and Nc=2. The first subframe set is composed of subframes with an odd index. of indicates a system frame number (or a radio frame index) and ns indicates a slot index in a radio frame. floor( ) indicates a rounddown function, and A mod B indicates a remainder obtained by dividing A by B.

Report 2 is located in some subframes in the first subframe set and Report 3 is located in the remaining subframes. In detail, Report 2 is located in a subframe with a subframe index satisfying (10*nf+floor(ns/2)−N offset, CQI) mod (H*Nc)=0. Accordingly, Report 2 is transmitted every interval of H*Nc, and one or more first subframes between adjacent Reports 2 are filled by transmitting Report 3. In case of PTI=0, H=M and M is determined via upper layer signaling. FIG. 14 illustrates a case of M=2. In case of PTI=1, H=J*K+1, K is determined via upper layer signaling, and J is the number of BPs. FIG. 14 illustrates a case of J=3 and K=1.

Report 1 is transmitted in a subframe with a subframe index satisfying (10*nf+floor(ns/2)−N offset, CQI-N offset, RI) mod (MRI*(J*K+1)*Nc)=0, and MRI is determined via upper layer signaling. N offset, RI corresponds to a relative offset value for RI. FIG. 14 illustrates a case of MRI=2 and N offset, RI=−1. According to N offset, RI=−1, transmission time for Report 1 and transmission time for Report 2 do not overlap each other. When a UE calculates RI, W1, and W2, RI, W1, and W2 are associated with each other. For example, W1 and W2 are calculated with dependence upon RI, and W2 is calculated with dependence upon W1. At a point of time when both Report 2 and Report 3 are reported after Report 1 is reported, a BS may know final W from W1 and W2.

CSI Feedback of Cooperative Multipoint Transmission/Reception (CoMP) System

Hereinafter, CoMP will be described.

A post LTE-A system tries to use a method for allowing cooperation between plural cells to enhance system performance. This method is referred to as cooperative multipoint transmission/reception (CoMP). CoMP refers to a scheme in which two or more BSs, access points, or cells communicate with a UE in cooperation with each other for smooth communication between a BS, an access point, or a cell with a specific UE. According to the present invention, a BS, an access point, and a cell may be used in the same meaning.

In general, in a multi-cell environment having a frequency reuse factor of 1, the performance of a UE located at a cell edge and average sector throughput may decrease due to inter-cell interference (ICI). To reduce ICI, a conventional LTE system uses a method for allowing a UE located at a cell edge in an interfered environment to have appropriate throughput using a simple passive scheme such as fractional frequency reuse (FFR) through UE-specific power control. However, it may be more preferable to reduce ICI or reuse ICI as a signal that a UE desires rather than decreasing frequency resource use per cell. To achieve this, a CoMP transmission scheme can be applied.

FIG. 15 illustrates an example of CoMP. Referring to FIG. 15, a wireless communication system includes a plurality of BSs BS1, BS2, and BS3 which perform CoMP and a UE. The plural BSs BS1, BS2, and BS3 which perform CoMP may effectively transmit data to the UE in cooperation with each other.

A CoMP transmission scheme may be classified into COMP joint processing (JP) via data sharing and CoMP-coordinated scheduling/beamforming (CS/CB).

According to CoMP-JP applicable to downlink, a UE may simultaneously receive data from a plurality of BSs that perform a CoMP transmission scheme and may combine signals received from the BSs to enhance reception performance (joint transmission; JT). In addition, one of BSs that perform a CoMP transmission scheme may transmit data to the UE at a specific point of time (Dynamic point selection; DPS). According to CoMP-CS/CB, the UE may momentarily receive data from one BS, that is, a serving BS via beamforming.

When CoMP-JP is applied to uplink, a plurality of BSs may simultaneously receive a PUSCH signal from a BS (Joint Reception; JR). On the other hand, in case of CoMP-CS/CB, only one BS may receive a PUSCH. Cooperative cells (or BSs) may determine to use coordinated scheduling/beamforming (CS/CB).

A UE using a CoMP transmission scheme, that is, a CoMP UE may transmit channel information as feedback (hereinafter, referred to as CSI feedback) to a plurality of BSs that perform a CoMP transmission scheme. A network scheduler may select an appropriate CoMP transmission scheme for increasing a transmission rate among CoMP-JP, CoMP-CS/CB, and DPS methods, based on the CSI feedback. To this end, a CoMP UE may configure the CSI feedback in a plurality of BSs that perform a CoMP transmission scheme according to a periodic feedback transmission scheme using UL PUCCH. In this case, feedback configuration of each BS may be independent from each other. Thus, hereinafter, in this specification, according to an embodiment of the present invention, an operation for transmitting channel information as feedback with independent feedback configuration is referred to as a CSI process. One or more CSI processes may be present in one serving cell.

FIG. 16 illustrates a case in which a DL CoMP operation is performed.

In FIG. 16, a UE is positioned between eNB1 and eNB2. The two eNBs (i.e., eNB1 and eNB2) perform an appropriate CoMP operation such as JT, DCS, and CS/CB in order to overcome interference with the UE. The UE performs appropriate CSI feedback for facilitating the CoMP operation of an eNB. Information transmitted via CSI feedback may include PMI information of each eNB and CQI information and may further include channel information (e.g., phase offset information between the two eNB channels) between the two eNBs for JT.

Although FIG. 16 illustrates a case in which the UE transmits a CSI feedback signal to eNB1 that is a serving cell of the UE, the UE may transmit the CSI feedback signal to eNB2 or the two eNBs according to a situation. In addition, although FIG. 16 illustrates a case in which a basic unit participating in CoMP is eNB, the present invention may be applied to CoMP between transmission points controlled by single eNB.

That is, for CoMP scheduling in a network, the UE needs to feedback DL CSI information of neighboring eNB/TP that participates in CoMP as well DL CSI information of serving eNB/TP. To this end, the UE may feedback a plurality of CSI processes that reflect various data transmission eNB/TP and various interference environments.

Thus, an LTE system uses an interference measurement resource (IMR) for interference measurement during calculation of CoMP CSI. One UE may be configured by a plurality of IMRs which have independent configuration. That is, the IMRs may be configured by independent periods, offsets, and resource configuration, and a BS may signal IMR to a UE via upper layer signaling (RRC, etc.).

In addition, an LTE system uses CSI-RS in order to measure a channel desired for calculation of CoMP CSI. One UE may be configured by a plurality of CSI-RSs which have independent configurations. That is, each CSI-RS may be configured by independent periods, offsets, resource configuration, power control (Pc), and number of antenna ports. CSI-RS related information may be signaled to a UE from a BS via upper layer signaling (RRC, etc.).

Among a plurality of CSI-RSs and a plurality of IMRs configured to the UE, one CSI process may be defined in association with one CSI-RS resource for signal measurement and one interference measurement resource (IMR) for interference measurement. The UE feedbacks CSI information obtained via different CSI processes to a network (e.g., a BS) with independent periods and subframe offsets).

That is, each CSI process has independent CSI feedback configurations. The CSI-RS resource, the IMR resource association information, and the CSI feedback configuration may be indicated to the UE by a BS via upper layer signaling for each respective CSI process. For example, it is assumed that the UE may be configured by three CSI processes shown in Table 1 below.

TABLE 1

| | Signal Measurement | |
|---|---|---|
| CSI Process | Resource (SMR) | IMR |
| CSI process 0 | CSI-RS 0 | IMR 0 |
| CSI process 1 | CSI-RS 1 | IMR 1 |
| CSI process 2 | CSI-RS 0 | IMR 2 |

In Table 1 above CSI-RS 0 and CSI-RS 1 are CSI-RS received from eNB 1 that is a serving eNB of the UE and CSI-RS received from eNB 2 as a neighboring eNB that participates in cooperation, respectively. When it is assumed that IMR configured for each respective CSI process of Table 1 above is configured as shown in Table 2 below,

TABLE 2

| IMR | eNB 1 | eNB 2 |
|---|---|---|
| IMR 0 | Muting | Data transmission |
| IMR 1 | Data transmission | Muting |
| IMR 2 | Muting | Muting |

With regard to IMR 0, eNB 1 performs muting and eNB 2 performs data transmission, and the UE is configured to measure interference from eNBs except for eNB 1 based on IMR 0. Similarly, with regard to IMR 1, eNB 2 performs muting and eNB 1 performs data transmission, and the UE is configured to measure interference from eNBs except for eNB 2 based on IMR 1. In addition, with regard to IMR 2, both eNB 1 and eNB 2 perform muting, and the UE is configured to measure interference from eNBs except for eNB 1 and eNB 2 based on IMR 2.

Accordingly, as shown in Tables 1 and 2, CSI information of CSI process 0 refers to optimum RI, PMI, and CQI information when data is received from eNB 1. CSI information of CSI process 1 refers to optimum RI, PMI, and CQI when data is received from eNB 2. CSI information of CSI process 2 refers to optimum RI, PMI, and CQI information when data is received from eNB 1 and interference is not generated from eNB 2.

CSI processes configured to one UE may share dependent values for CoMP scheduling. For example, in case of joint transmission (JP) of transmission point 1 (TP 1) and TP 2, when CSI process 1 in which a channel of cell/TP 1 is considered as a signal part and CSI process 2 in which a channel of TP 2 is considered as a signal part are configured to one UE, rank of CSI process 1 and CSI process 2 needs to be the same as a selected subband index in order to easily perform JT scheduling.

Collision of CSI of CoMP

For CoMP scheduling, a UE needs to feedback channel information of channel information of a transmission point (TP) or a neighboring cell that participates in CoMP as well as channel information of a serving cell or a serving TP to a BS. Accordingly, for CoMP, the UE feedbacks CSI according to a plurality of CSI processes that reflect an interference environment with a plurality of cells or TP.

One CSI process is defined by one CSI-RS resource for signal measurement and one interference measurement resource (IMR) association for interference measurement. In addition, each CSI process has independent CSI feedback configuration. CSI feedback configuration includes a feedback mode, a feedback period, offset, etc.

CSI processes configured to one UE may share dependent values for CoMP scheduling. For example, in case of joint transmission (JP) of a first cell and a second cell, a first CSI process for the first cell and a second CSI process for the second cell need to have the same RI and subband index in order to easily perform JT scheduling.

Accordingly, some or all CSI processes among CSI processes configured to a UE may be limited to have common CSI (e.g., RI) value. For convenience of description, among CSI processes limited to have the common CSI value, a CSI process as reference for configuration of a CSI value is referred to as a reference CSI process, and CSI processes except for the reference CSI process are each referred to as a following CSI process. The following CSI process may feedback the same value as a CSI value of the reference CSI process without separate calculation.

Here, CSI feedback configuration of each CSI process may be independently configured, and thus collision between CSI processes may occur. That is, CSI feedback configuration may be configured to feedback a reporting type of one CSI process and a reporting type of another CSI process at the same point of time to cause collision between CSI processes. For example, when periodic CSI feedback is performed with a predetermined period and offset, collision whereby a plurality of CSI is feedback on the same subframe may occur.

Hereinafter, a method for handling collision between reporting types containing RI when collision between CSI processes occurs will be proposed. For example, the method can be applied to a case in which collision occurs between type 3, type 5, and type 6 among CSI reporting types defined in LTE release-10. CSI reporting type defined in LTE release-10 will now be described.

Type 1 report supports CQI feedback for a UE in a selected subband. Type 1a report supports subband CQI and second PMI feedback. Type 2, type 2b, and type 2c reports support wideband CQI and PMI feedback. Type 2a report supports wideband PMI feedback. Type 3 report supports RI feedback. Type 4 report supports wideband CQI. Type 5 report supports RI and wideband PMI feedback. Type 6 report supports RI and PTI feedback.

As defined in LTE release-10, when collision between CSI processes occurs, drop priority is determined according to a reporting type. When drop priority according to a reporting type is constant, a CSI process having a second low CSI process index has high priority. CSI reports types 3, 5, and 6 have the same priority and priority is constant according to a reporting type. Thus, CSI processes except for a CSI process having a lowest index is dropped.

Hereinafter, a method for processing collision when type 6 report of the following CSI process collides with type 3, type 5, or type 6 report of the CSI process will be proposed.

According to embodiments of the present invention, the UE preferentially feedbacks a report of the reference CSI process and drops type 6 report of the following CSI process. That is, an index of the reference CSI process may be configured lower than an index of the following CSI process. In this case, type 6 report of the following CSI process drops PTI joint-encoded together with RI. In this regard, the UE may determine the dropped PTI value using the following method.

First, the UE may determine a PTI value of the following CSI process as a PTI value of the reference CSI process.

In detail, when type 6 report of the following CSI process collides with type 3, type 5, and type 6 reports of the reference CSI process, the UE determines the PTI value of the following CSI process as the PTI value of the reference CSI process that is currently feedback. That is, after collision occurs, the UE calculates and reports CQI or PMI of the following CSI process based on the PTI value of the reference CSI process. Then, when the UE feedbacks type 6 report of the following CSI process without collision, the UE calculates CQI or PMI based on a newly feedback PTI value of the following CSI process instead of the PTI value of the reference CSI process.

Then, the UE may determine the PTI value of the following CSI process as a default PTI value.

In detail, when type 6 report of the following CSI process collides with type 3, type 5, or type 6 report of the reference CSI process, the UE determines the PTI value of the following CSI process as the default PTI value. The default PTI value may be 0 or 1. In addition, the BS and the UE may share a predetermined default PTI value. Then, when the UE feedbacks type 6 report of the following CSI process without collision, the UE calculates CQI or PMI based on a newly feedback PTI value of the following CSI process instead of the default PTI value.

Then, the UE may determine the PTI value of the following CSI process as a PTI value that is most recently reported according to the following CSI process.

In detail, when type 6 report of the following CSI process collides with type 3, type 5, or type 6 report of the reference CSI process, the UE determines the PTI value that is most recently reported according to the following CSI process. Then, when the UE feedbacks type 6 report of the following CSI process without collision, the UE calculates CQI or PMI based on a newly feedback a PTI value of the following CSI process instead of the PTI value that is most recently reported according to the following CSI process.

When type 6 report of the following CSI process collides with type 3, type 5, or type 6 report of the reference CSI process, the UE may multiplex the PTI value of the following CSI process to the reference CSI process and report the multiplexed value.

Hereinafter, a method for handling collision when type 5 report of the following CSI process collides with type 3, type 5, or type 6 report of the reference CSI process will be proposed. That is, based on the aforementioned method, a case in which type 5 report of the following CSI process instead of type 6 report of the following CSI process collides with type 3, type 5, or type 6 of the reference CSI process will be described below.

According to embodiments of the present invention, the UE preferentially feedbacks a report of the reference CSI process and drops type 5 report of the following CSI process. That is, an index of the reference CSI process may be configured lower than an index of the following CSI process. In this case, type 5 report of the following CSI process drops wideband PTI (W1) joint-encoded with RI. In this regard, the UE the dropped W1 value using the following method.

First, the UE may determine a W1 value of the following CSI process as a W1 value of the reference CSI process.

In detail, when type 5 report of the following CSI process collides with type 5 report of the reference CSI process, the UE determines the W1 value of the following CSI process as the W1 value of the reference CSI process that is currently feedback. That is, after collision occurs, the UE calculates and reports CQI or PMI of the following CSI process based on the W1 value of the reference CSI process. Then, when the UE feedbacks type 5 report of the following CSI process without collision, the UE calculates CQI or PMI based on a newly feedback W1 value of the following CSI process instead of the W1 value of the reference CSI process.

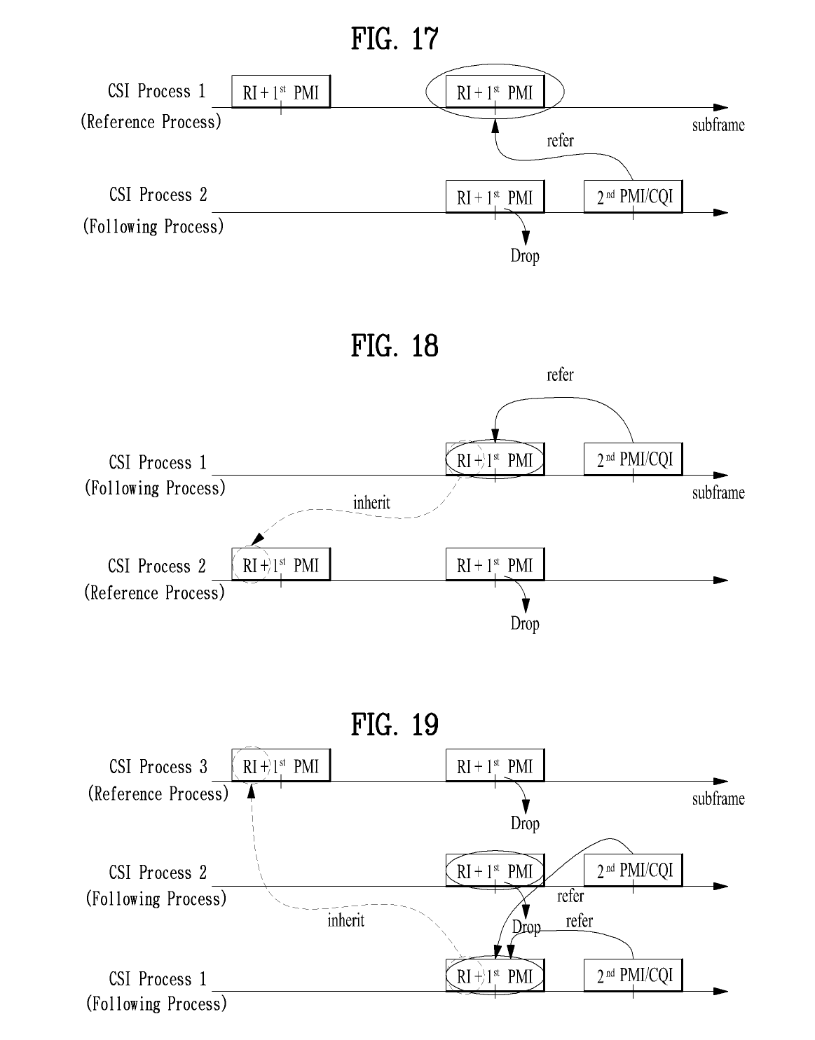

FIG. 17 illustrates an example of determining a W1 value of the reference CSI process as a W1 value of the following CSI process when type 5 report of the following CSI process collides with type 5 report of the reference CSI process.

Referring to FIG. 17, when CSI process 1 as the reference CSI process collides with type 5 report of CSI process 2 as the following CSI process, a UE drops type 5 report of CSI process 2 as the following CSI process. After type 5 report of CSI process 2 is dropped, the UE calculates and reports CQI or PMI of CSI process 2 as the following CSI process based on a W1 value of CSI process 1 as the reference CSI process.

Then, the UE may determine the W1 value of the following CSI process as a default W1 value.

In detail, when type 5 report of the following CSI process collides with type 3, type 5, and type 6 reports of the following CSI process, the UE determines the W1 value of the following CSI process as the default W1 value. The default value may be 0 or 1. In addition, the BS and the UE may share a predetermined default W1 value. Then, when the UE feedbacks type 5 report of the following CSI process without collision, the UE calculates CQI or PMI based on a newly feedback W1 value of the following CSI process instead of the default W1 value.

Then, the UE may determine the W1 value of the following CSI process as a W1 value that is most recently reported according to the following CSI process.

In detail, when type 5 report of the following CSI process collides with type 3, type 5, or type 6 report of the reference CSI process, the UE determines the W1 value that is most recently reported according to the following CSI process. Then, when the UE feedbacks type 5 report of the following CSI process without collision, the UE calculates CQI or PMI based on a newly feedback a W1 value of the following CSI process instead of the W1 that is most recently reported according to the following CSI process.

When type 5 report of the following CSI process collides with type 3, type 5, or type 6 report of the reference CSI process, the UE may multiplex the W1 value of the following CSI process to the reference CSI process and report the multiplexed value.

FIG. 18 illustrates another embodiment of a case in which type 5 report of the following CSI process collides with type 5 report of the reference CSI process.

When type 5 report of the following CSI process collides with type 5 report of the reference CSI process, the UE may not preferentially report the reference CSI process and may determine priority according to the following drop rule. While CSI processes collide with each other, the UE may apply high priority in an order of reporting type, a CSI process index, and a component carrier (CC) index. In this case, the situation illustrated in FIG. 18 may occur.

Referring to FIG. 18, the following CSI process has CSI process index 1, the reference CSI process has CSI process index 2, and the two CSI processes collide at a predetermined point of time. According to the aforementioned drop rule, reporting types of the two CSI processes are the same, and thus, the UE determines priority according to a CSI process index. Accordingly, the UE drops CSI of the reference CSI process having a high CSI process index. In this case, RI of the following CSI process inherits an RI value that is most recently reported according to the reference CSI process. In addition, a W1 value of the following CSI process, which is joint-encoded with the RI, may not be inherited and may be independently determined. In FIG. 17, since W1 of the following CSI process is also dropped, it is effective to inherit W1 of the reference CSI process. However, in FIG. 18, since W1 of the following CSI process is not dropped, W1 of the flowing CSI process may be independently determined. In FIG. 18, W2 and CQI of the following CSI process are calculated based on most-recently reported RI and W1 after collision. In this case, RI is a RI value of the reference CSI process before collision occurs, and W1 is independently determined in the following CSI process based on the RI value.

FIG. 19 illustrates an embodiment in which three CSI processes collide, which is obtained by expanding the case of FIG. 18.

Referring to FIG. 19, CSI processes 1 and 2 are configured as the following CSI process, CSI process 3 is configured as the reference CSI process, and three CSI processes collide at a predetermined point of time. According to the aforementioned drop rule, CSI process 2 having a high CSI process index and CSI process 3 as the reference CSI process are dropped. In this case, RI of CSI process 1 inherits an RI value that is most recently reported according to the reference CSI process. In addition, W1 joint-encoded with the RI may not be inherited and may be independently determined. CSI process 2 inherits RI and W1 of CSI process 1. That is, when the reference CSI process collides with two or more following CSI processes, from a point of view of one following CSI process, if both a report of the following CSI process and a report of the reference CSI process are dropped, the following CSI process inherits a value of the other following CSI process. In FIG. 19, RI of CSI process 2 inherits RI of CSI process 1. W1 of CSI process 2 inherits W1 of CSI process 1, and W1 of CSI process 1 is independently determined from the reference CSI process. In result, CSI process 2 inherits a value of the other following CSI process instead of the W1 value of the reference CSI process.

FIG. 19 illustrates an example in which RI and PMI are joint-encoded. However, a case in which the following CSI process inherits a value of the other following CSI process when the reference CSI process collides with two or more following CSI processes can also be applied to a case in which only RI is reported or RI and PTI are joint-encoded.

As illustrated in FIG. 18 or 19, when an index of the reference CSI process is higher than an index of the following CSI process, problems arise in that the reference CSI process is dropped and an inherited R1 value of the reference CIS process is the same as a past value. That is, problems arise in that past channel information is reported to reduce accuracy of channel state information feedback. Accordingly, when the reference CSI process and the following CSI process collide with each other, an index of the reference CSI process may be configured lower than an index of the following CSI process so as not to drop the reference CSI process. In addition, an index of the reference CSI process may be fixed and configured to 1 that is a lowest CSI process index. In this case, the UE expects that a BS configures an index of the reference CSI process as 1.

Since an index of the reference CSI process is higher than an index of the following CSI process and periods and offsets of RIs of the two CSI processes are the same, the two CSI processes always collide with each other, problems arise in that the reference CSI process is always dropped and the following CSI process cannot be inherited. The problem can be overcome using the following methods. First, when an index of the reference CSI process is configured higher than an index of the following CSI process, periods and offsets of the two CSI processes are not configured to be the same. Then, when the periods and offsets of the reference CSI process and the following CSI process are the same, the index of the reference CSI process is not configured higher than the index of the following CSI process. In addition, the index of the reference CSI process may be configured as 1.

Contradiction of Application of Common CSI in CoMP

Codebook subset restriction refers to restriction in which a UE selects a precoder only in a subset composed of elements in a codebook. That is, the codebook subset restriction refers to generation of a codebook including various precoding matrices and then restriction of available precoding matrices for each respective cell or UE. When the codebook subset restriction is used, a wireless communication system has a codebook with a large size, but a codebook used by each UE is composed of subsets of the codebook to increase precoding gain.

Here, when codebook subset restriction is independently configured for each respective CSI process, problems may arise in that it is impossible to configure RI of the following CSI process as the same value as RI (common RI) of the reference CSI process. That is, problems may arise in terms of application of the common RI due to the codebook subset restriction. For example, when the codebook subset restriction is configured in such a way that the reference CSI process uses ranks 1 and 2 and the codebook subset restriction is configured in such a way that the following CSI process uses only rank 1, problems may arise in that available RIs are different. That is, when RI of the reference CSI process is 2, the following CSI process cannot configure a rank of the following CSI process as 2 due to the codebook subset restriction. In this case, the UE may perform the following procedure.

First, the UE may determine and feedback RI of the following CSI process separately from RI of the reference CSI process, which means that the codebook subset restriction is preferentially applied compared with application of RI of the reference CSI process. Accordingly, in this case, the common RI is not applied. When RI of the following CSI process is selected, the UE determines available RIs according to the codebook subset restriction of the following CSI process and selects an optimum RI among the available RIs based on a measurement value of non zero power (NZP) CSI and IMR of the following CSI process.

Then, the UE may determine RI of the following CSI process as the same value as RI of the reference CSI process, which means that RI of the reference CSI process is preferentially applied compared with application of the codebook subset restriction. Accordingly, in this case, the codebook subset restriction of the following CSI process is not applied.

Then, available RIs may be determined using the codebook subset restriction of the following CSI process and a most approximate RI to RI of the reference CSI process may be selected among the available RIs. In case of periodic feedback, RI of the following CSI process refers to a most recent value among values when or before RI of the following CSI process is reported. In case of aperiodic feedback, RI of the following CSI process refers to a value that is reported at the same time as RI of the following CSI process.

Then, available RIs may be determined using the codebook subset restriction of the following CSI process and a smallest RI may be selected among the available RIs.

As described above, in order to prevent contradiction of application of codebook subset restriction of the following CSI process and the common RI, codebook subset restrictions may not be independently configured for respective CSI processes. That is, a BS may configure the following CSI process and the reference CSI process to have the same codebook subset restriction and a UE may expect that the following CSI process and the reference CSI process have the same codebook subset restriction.

In addition, in order to prevent the aforementioned problem, the BS may configure codebook subset restriction of the following CSI process and the reference CSI process such that an available RI of the following CSI process is the same as an available RI of the reference CSI process. That is, the UE may expect that codebook subset restrictions of the following CSI process and the reference CSI process are configured such that an available RI of the following CSI process is the same as an available RI of the reference CSI process. Similarly, the UE may not expect that codebook subset restrictions of the following CSI process and the reference CSI process are configured such that an available RI of the following CSI process is different from an available RI of the reference CSI process.

In order to prevent the aforementioned problem, the BS may configure codebook subset restriction of the following CSI process and the reference CSI process such that a set of available RIs of the following CSI process is a set or superset of available RIs of the reference CSI process. That is, the UE may expect that the codebook subset restrictions of the following CSI process and the reference CSI process are configured such that the set of the available RIs of the following CSI process is the set or superset of the available RIs of the reference CSI process. Similarly, the UE may not expect that the codebook subset restrictions of the following CSI process and the reference CSI process are configured such that the set of the available RIs of the following CSI process is not included in the set of the available RIs of the reference CSI process.

Although the aforementioned features have been described in terms of contradiction between codebook subset restriction of the following CSI process and application of the common RI, the present invention is not limited thereto. That is, the present invention can also be applied to a case of contraction between codebook subset restriction of the following CSI process and application of a common PMI.

Hereinafter, a procedure of a case in which application of the common PMI contradicts codebook subset restriction of the following CSI process will be described.

First, the UE may determine and feedback PMI of the following CSI process separately from PMI of the reference CSI process, which means that the codebook subset restriction is preferentially applied compared with application of PMI of the reference CSI process. Accordingly, in this case, the common PMI is not applied. When PMI of the following CSI process is selected, the UE determines available PMIs according to the codebook subset restriction of the following CSI process and selects an optimum PMI among the available PMIs based on a measurement value of non zero power (NZP) CSI and IMR of the following CSI process.

Then, the UE may determine PMI of the following CSI process as the same value as PMI of the reference CSI process, which means that PMI of the reference CSI process is preferentially applied compared with application of the codebook subset restriction. Accordingly, in this case, the codebook subset restriction of the following CSI process is not applied.

Then, available PMIs may be determined using the codebook subset restriction of the following CSI process and a most approximate PMI to PMI of the reference CSI process may be selected among the available PMIs. For example, an approximation degree between two PMIs may be determined according to co-relation or euclidean distance between the two PMIs. In detail, as the co-relation increases or the euclidean distance decreases, the two PMIs may be determined to be approximate. In case of periodic feedback, PMI of the following CSI process refers to a most recent value among values when or before PMI of the following CSI process is reported. In case of aperiodic feedback, PMI of the following CSI process refers to a value that is reported at the same time as PMI of the following CSI process.

Then, available PMIs may be determined using the codebook subset restriction of the following CSI process and a smallest PMI may be selected among the available PMIs.

As described above, in order to prevent contradiction of application of codebook subset restriction of the following CSI process and the common CSI, subset restrictions may not be independently configured for respective CSI processes. That is, a BS may configure the following CSI process and the reference CSI process to have the same codebook subset restriction and a UE may expect that the following CSI process and the reference CSI process have the same codebook subset restriction.

Hereinafter, similarly to a case in which codebook subset restriction contradicts common CSI, a case in which the number of CSI-RS antenna ports of the following CSI process is different from the number of CSI-RS antenna ports of the reference CSI process will be described.

When the number of CSI-RS antenna ports of the following CSI process is different from the number of CSI-RS antenna ports of the reference CSI process, it may be impossible to configure RIs and PMIs of the two CSI processes to have the same value. For example, when the number of CSI-RS antenna ports of the following CSI process and the number of CSI-RS antenna ports of the reference CSI process are configured as 4 and 8, respectively, if RI of the reference CSI process is configured as 8, RI of the following CSI process cannot be configured to have the same value as RI of the reference CSI process.

In order to prevent this problem, a BS may configure the number of CSI-RS antenna ports of the following CSI process and the number of CSI-RS antenna ports of the reference CSI process to have the same value. In this case, a UE may expect that the number of CSI-RS antenna ports of the following CSI process and the number of CSI-RS antenna ports of the reference CSI process have the same value. Similarly, the UE may not expect that number of CSI-RS antenna ports of the following CSI process is different from the number of CSI-RS antenna ports of the reference CSI process.

As another method, the BS may configure the number of CSI-RS antenna ports of the reference CSI process to have a value equal to or greater than number of CSI-RS antenna ports of the reference CSI process. That is, the UE may expect that the number of CSI-RS antenna ports of the reference CSI process has a value equal to or greater than number of CSI-RS antenna ports of the reference CSI process. When the number of CSI-RS antenna ports of the reference CSI process has a value equal to or greater than number of CSI-RS antenna ports of the reference CSI process, any problem does not occur.

As another method, when the that number of CSI-RS antenna ports of the following CSI process is different from the number of CSI-RS antenna ports of the reference CSI process, the UE may calculate RI and PMI of the following CSI process separately from RI and PMI of the reference CSI process. In addition, when that number of CSI-RS antenna ports of the following CSI process is smaller than the number of CSI-RS antenna ports of the reference CSI process, the UE may calculate RI and PMI of the following CSI process separately from RI and PMI of the reference CSI process.

Hereinafter, contradiction of application of common CSI in case of independent configuration of whether to enable RI and PMI reports for respective CSI processes will be described.

When whether to enable RI and PMI reports for respective CSI processes is independently configured, it may be impossible to determine RI of the following CSI process as the same value as RI of the reference CSI process. For example, when RI and PMI reports of the reference CSI process are enabled and RI is configured as 2 but RI and PMI reports of the following CSI process is disabled, it may be impossible to configure rank of the following CSI process as 2. In this case, the UE may perform the following process.

First, the UE may disable RI and PMI reports of the following CSI process, which means that disable configuration of RI report of the following CSI process is preferentially applied compared with application of RI of the reference CSI process. In this case, RI of the reference CSI process is not applied.

Then, the UE may determine RI of the following CSI process as the same value as RI of the reference CSI process, which means that RI of the reference CSI process is preferentially applied compared with application of disable configuration of RI and PMI reports of the following CSI process. In this case, RI and PMI reports of the following CSI process are not valid.

In order to prevent the aforementioned problem, RI and PMI reports of the following CSI process and the reference CSI process may always be enabled. In this case, the BS may configure RI and PMI reports of the following CSI process and the reference CSI process to be enabled. The UE may expect that RI and PMI reports of the following CSI process and the reference CSI process are enabled.

Priority in Case of Collision of CSI Process

Hereinafter, a method for determining reported CSI and dropped CSI according to priority when two or more CSI processes collide with each other in periodic CSI feedback using PUCCH will be described.

In case of collision between CSI processes, priority of CSI reporting defined in current LTE release-10 will now be described. When CSI processes collide, a UE applies high priority in an order of reporting type, a CSI process index, and a component carrier (CC) index.

For example, after priority of reporting type is first considered, when priority of reporting type is constant, a lower index has higher priority based on a CSI process index. When priority of reporting type is constant and CSI process index is constant, a CSI process having a lower CC index has higher priority.

Priority according to reporting type is determined as follows. In a corresponding subframe, when CSI report of PUCCH reporting type 3, 5, 6, or 2a collides with CSI report of PUCCH reporting type 1, 1a, 2, 2b, 2c, or 4, the latter is dropped with low priority. In a corresponding subframe, when CSI report of PUCCH reporting type 2, 2b, 2c, or 4 collides with CSI report of PUCCH reporting type 1 or 1a, the latter is dropped with low priority.

The present invention proposes detailed priority from the aforementioned conventional priority of reporting type. According to the present invention, in a corresponding subframe, when CSI report of PUCCH reporting type 5 or 6 collides with CSI report of PUCCH reporting type 3, the latter is dropped with low priority.

The aforementioned priority between PUCCH reporting types 3, 5, and 6 can be applied to collision between the reference CSI process and the following CSI process. For example, reporting type 6 of the following CSI process collides with reporting type 3 of the reference CSI process in the same subframe, CSI report of reporting type 3 is dropped and reporting type 6 of the following CSI process is reported.

PUCCH reporting type 6 is joint-encoded with PTI as well as RI, and thus, the priority according to the present invention may be applied so as to report PTI as well as RI without loss. Similarly, PUCCH reporting type 5 is joint-encoded with W1 as well as RI, and thus, the priority according to the present invention may be applied so as to report W1 as well as RI without loss.

In this case, RI of the reference CSI process is dropped, but the same value as RI of the reference CSI process is reported via type 5 or 6. Accordingly, the UE calculates PMI and CQI of the reference CSI process based on RI of type 5 or 6 until RI of a next reference CSI process is reported.

In a conventional system, ACK/NACK report for data and CSI (RI/PMI/subband index) feedback collide, the ACK/NACK report is preferentially handled and the CSI is dropped. However, when CSI of the reference CSI process collides with the ACK/NACK report, CSI report of the reference CSI process may have higher priority than the ACK/NACK report. According to this, CSI of the reference CSI process is reported and the ACK/NACK report is dropped. This is because CSI of the reference CSI process is referred by one or more following CSI processed and thus affects CSI of the following CSI process when CSI report of the reference CSI process is dropped. Accordingly, when CSI of the reference CSI process and the ACK/NACK report collide, CSI report of the reference CSI process may have higher priority than the ACK/NACK report.

BS and UE to which embodiments of the present invention are applicable

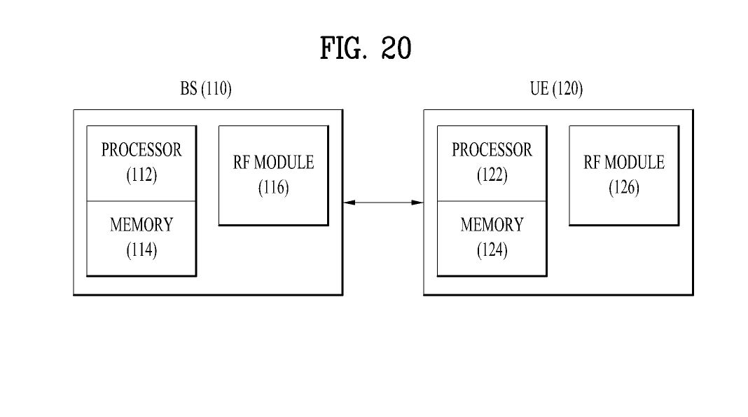

FIG. 20 is a diagram illustrating a BS 110 and a UE 120 to which an embodiment of the present invention is applicable.

When a relay is included in a wireless communication system, communication in backhaul link is performed between the BS and the relay, and communication in access link is performed between the relay and the UE. Accordingly, the BS or the UE illustrated in FIG. 20 may be replaced by a relay as necessary.

Referring to FIG. 20, the wireless communication system includes a BS 110 and a UE 120. The BS 110 includes a processor 112, a memory 114, and a radio frequency (RF) unit 116. The processor 112 may be configured to embody procedures and/or methods proposed by the present invention. The memory 114 is connected to the processor 112 and stores various information related to an operation of the processor 112. The RF unit 116 is connected to the processor 112 and transmits and/or receives a radio signal. The UE 120 includes a processor 122, a memory 124, and an RF unit 126. The processor 122 may be configured to embody procedures and/or methods proposed by the present invention. The memory 124 is connected to the processor 122 and stores various information related to an operation of the processor 122. The RF unit 126 is connected to the processor 122 and transmits and/or receives a radio signal. The BS 110 and/or the UE 120 may have a single antenna or a multiple antenna.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by a subsequent amendment after the application is filed.

In the embodiments of the present invention, a specific operation described as being performed by the BS may be performed by an upper node of the BS. Namely, it is apparent that, in a network comprised of a plurality of network nodes including a BS, various operations performed for communication with a UE may be performed by the BS, or network nodes other than the BS. The term ‘BS’ may be replaced with a fixed station, a Node B, an eNode B (eNB), an access point, etc.

The embodiments according to the present invention can be implemented by various means, for example, hardware, firmware, software, or combination thereof. In a hardware configuration, the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, the embodiments of the present invention can be implemented by a type of a module, a procedure, or a function, which performs functions or operations described above. Software code may be stored in a memory unit and then may be executed by a processor.

The memory unit may be located inside or outside the processor to transmit and receive data to and from the processor through various means which are well known.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The above-described embodiments of the present invention can be applied to a wireless communication system such as a user equipment (UE), a relay, a base station (BS), etc.

1-14. (canceled)

15. A method for transmitting Channel State Information (CSI) in a wireless access system, the method performed by a user equipment and comprising:
providing a first report for a first CSI process and a second report for a second CSI process, wherein the first report and the second report are type 5 report which reports a Rank Indicator (RI) and a wideband Precoding Matrix Indicator (PMI);
dropping the second report of the second CSI process having a higher CSI process index than the first CSI process in case of collision of the first report with the second report; and
configuring a second wideband PMI of the second report same as a first wideband PMI of the first report,
wherein a second RI of the second report is configured same as a first RI of the first report.

16. The method of claim 15, wherein if a plurality of CSI reports with same reporting type collide with each other, the plurality of CSI reports are dropped other than a CSI report of a CSI process having a lowest CSI process index.

17. The method of claim 15, wherein if a plurality of CSI reports with same reporting type collide with each other, a CSI report of a CSI process having a lowest CSI process index is reported.

18. The method of claim 15, wherein information for the first CSI process and the second CSI process is transmitted using Radio Resource Control (RRC) signaling.

19. The method of claim 15, wherein information included in the second report is determined according to the first wideband PMI of the first report after the step of colliding.

20. The method of claim 15, wherein the second wideband PMI of the second report is determined independently of the first wideband PMI of the first report, if the first report and the second report do not collide each other after the step of colliding.

21. A method for receiving Channel State Information (CSI) in a wireless access system, the method performed by a base station and comprising:
receiving a first report for a first CSI process and a second report for a second CSI process, wherein the first report and the second report are type 5 report which reports a Rank Indicator (RI) and a wideband Precoding Matrix Indicator (PMI); and
receiving the first report of the first CSI process having a lower CSI process index than the second CSI process in case of collision of the first report with the second report,
wherein a second RI of the second report is configured same as a first RI of the first report, and
wherein a second wideband PMI of the second report is configured same as a first wideband PMI of the first report.

22. The method of claim 21, wherein if a plurality of CSI reports with same reporting type collide with each other, the plurality of CSI reports are dropped other than a CSI report of a CSI process having a lowest CSI process index.

23. The method of claim 21, wherein if a plurality of CSI reports with same reporting type collide with each other, a CSI report of a CSI process having a lowest CSI process index is reported.

24. The method of claim 21, wherein information for the first CSI process and the second CSI process is transmitted using Radio Resource Control (RRC) signaling.

25. The method of claim 21, wherein information included in the second report is determined according to the first wideband PMI of the first report after the step of colliding.

26. The method of claim 21, wherein the second wideband PMI of the second report is determined independently of the first wideband PMI of the first report, if the first report and the second report do not collide each other after the step of colliding.

27. A user equipment for transmitting Channel State Information (CSI) in a wireless access system, the user equipment comprising:
a radio frequency (RF) unit; and
a processor configured to:
provide a first report for a first CSI process and a second report for a second CSI process, wherein the first report and the second report are type 5 report which reports a Rank Indicator (RI) and a wideband Precoding Matrix Indicator (PMI);
drop the second report of the second CSI process having a higher CSI process index than the first CSI process in case of collision of the first report with the second report; and
configure a second wideband PMI of the second report same as a first wideband PMI of the first report,
wherein a second RI of the second report is configured same as a first RI of the first report.

28. A base station for receiving Channel State Information (CSI) in a wireless access system, the base station comprising:
a radio frequency (RF) unit; and
a processor configured to:
receive a first report for a first CSI process and a second report for a second CSI process, wherein the first report and the second report are type 5 report which reports a Rank Indicator (RI) and a wideband Precoding Matrix Indicator (PMI); and
receive the first report of the first CSI process having a lower CSI process index than the second CSI process in case of collision of the first report with the second report,
wherein a second RI of the second report is configured same as a first RI of the first report, and
wherein a second wideband PMI of the second report is configured same as a first wideband PMI of the first report.
